(19) United States
(12) Patent Application Publication
(10) Pub. No.: US 2026/0236649 A1
(43) Pub. Date: Aug. 13, 2026

(54) SIMULATION AND OPTIMIZATION DESIGN METHODS AND SYSTEMS FOR EMU OBSTACLE REMOVAL SNOWPLOWS BASED ON MULTI-PHYSICAL FIELD COUPLING

(71) Applicant: CENTRAL SOUTH UNIVERSITY, Changsha (CN)

(72) Inventors: Chengxing YANG, Changsha (CN); Jing LING, Changsha (CN); Jun YANG, Changsha (CN); Ping XU, Changsha (CN); Jiefu LIU, Changsha (CN); Xiaobai LI, Changsha (CN); Wei ZHOU, Changsha (CN); Shuguang YAO, Changsha (CN); Zhao NAN, Changsha (CN)

(73) Assignee: CENTRAL SOUTH UNIVERSITY, Changsha (CN)

(21) Appl. No.: 19/441,815

(22) Filed: Jan. 6, 2026

(30) Foreign Application Priority Data
Feb. 11, 2025 (CN) 202510150088.3

(51) Int. Cl. G06F 30/28; G06F 30/25; G06F 111/10; G06F 113/08

(52) U.S. Cl. CPC G06F 30/28; G06F 30/25; G06F 2111/10; G06F 2113/08

(57) ABSTRACT

Provided is a simulation and optimization design method for an EMU obstacle removal snowplow based on multi-physical field coupling, the method includes collecting a snowfall amount and a snow accumulation density as snow environmental parameters of a target line; establishing a dynamic soft-sphere model of snow particles based on a Hertz-Mindlin with JKR cohesion contact model; simulating a wall snow accretion process using a discrete phase model and verifying simulation accuracy; constructing a parametric snowplow model, introducing shape parameters to correct a running resistance coefficient, evaluating snow removal performance, and selecting an optimal geometric parameter combination; integrating a train nose to form a whole vehicle model, correcting a snow removal resistance formula under multi-body coupling, and generating a selection recommendation of the snowplow; simulating different snow depths and running velocities, establishing an association model, and outputting a maximum safe vehicle velocity threshold that satisfies operation constraints.

### CROSS-REFERENCE TO RELATED APPLICATIONS

This application claims priority to the Chinese Patent Application No. 202510150088.3, filed on Feb. 11, 2025, the contents of which are hereby incorporated by reference.

### TECHNICAL FIELD

The present disclosure relates to the technical field of railway vehicle obstacle removal, in particular to simulation and optimization design methods and systems for EMU obstacle removal snowplows based on multi-physical field coupling.

### BACKGROUND

Frequent snowfall imposes significant constraints on railway transportation capacity in high-cold regions. The influence of railway snow accumulation on railway transportation mainly includes the influence of snow removal resistance generated in a snow removal process on running of a train and the influence of the snow removal process on surrounding environments, such as more snow accumulation on adjacent railways. When a high-velocity train runs on a snow-covered route, a snow layer accumulated along the running route collides with the train body, and snow removal resistance in a running direction caused by the collision increases the load of a train power system. The snow removal process may affect the wheel load of the train, reduce running stability and comfort, and, in severe cases, pose a risk of overturning.

However, existing designs of obstacle removal snowplows mainly rely on empirical experience and physical experiments, and lack in-depth research on snow removal mechanical mechanisms under different snow depths, running velocities, and geometric shapes of snowplows. The design approach not only leads to high costs and long cycles during experimental processes, but also makes timely adjustment and optimization of design schemes difficult when actual operation conditions change rapidly. Particularly in case of deep snow accumulation or high-velocity running, snow removal resistance may suddenly increase, resulting in the rate of wheel load reduction exceeding a safety design standard, posing a severe threat to running safety of the train.

Therefore, it is desirable to provide simulation and optimization design methods and systems for EMU obstacle removal snowplows based on multi-physical field coupling.

### SUMMARY

The purpose of the present disclosure: in order to overcome the above deficiencies, the purpose of the present disclosure is to provide a simulation and optimization design method and system for an EMU obstacle removal snowplow based on multi-physical field coupling.

To solve the above technical problems, the present disclosure provides a simulation and optimization design method for an EMU obstacle removal snowplow based on multi-physical field coupling, comprising:
S1: collecting a snow environmental parameter of a target line, wherein the snow environmental parameter includes at least snowfall data and snow accumulation data;
S2: establishing a soft sphere model of snow particles and determining a contact force between the snow particles using a Hertz-Mindlin with JKR cohesion contact model;
S3: performing snow accretion simulation based on a wall snow accretion criterion using a discrete phase model, and then verifying correctness of a snow removal resistance formula in the snow accretion simulation by comparing with preset snow removal experimental data;
S4: establishing an obstacle removal snowplow model using a parametric modeling approach, and introducing a shape parameter into the snow removal resistance formula based on a simulation result of the snow accretion simulation to simplify a running resistance coefficient, and then evaluating snow removal performance of the obstacle removal snowplow under a preset shape parameter combination to determine the snow removal resistance formula of the obstacle removal snowplow;
S5: adding a train nose to the obstacle removal snowplow model to form a whole vehicle model and performing simulation based on the whole vehicle model, and then correcting the snow removal resistance formula and generating a selection recommendation of the obstacle removal snowplow;
S6: performing simulation under a preset snow depth and running velocity to obtain train forces and snow removal paths under different snow depths and running velocities, and then generating a maximum velocity capable of satisfying an actual operation requirement under different snow depths based on a preset constraint condition; and
S7: outputting an optimal design parameter of the obstacle removal snowplow.

The present disclosure further provides a simulation and optimization design system for an EMU obstacle removal snowplow based on multi-physical field coupling adopting the method, comprising: a data acquisition module configured to collect a snow environmental parameter of a target line, wherein the snow environmental parameter includes at least snowfall data and snow accumulation data; a model processing module configured to establish a soft sphere model of snow particles and determine a contact force between the snow particles using a Hertz-Mindlin with JKR Cohesion contact model; a simulation module configured to perform snow accretion simulation based on a wall snow accretion criterion using a discrete phase model, and then verify correctness of a snow removal resistance formula in the snow accretion simulation by comparing with preset snow removal experimental data; a resistance determination module configured to establish an obstacle removal snowplow model using a parametric modeling approach, and introduce a shape parameter into the snow removal resistance formula based on a simulation result of the snow accretion simulation to simplify a running resistance coefficient, and then evaluate snow removal performance of the obstacle removal snowplow under a preset shape parameter combination to determine the snow removal resistance formula of the obstacle removal snowplow; an obstacle removal selection module configured to add a train nose to the obstacle removal snowplow model to form a whole vehicle model and perform simulation based on the whole vehicle model, and then correct the snow removal resistance formula and generate a selection recommendation of the obstacle removal snowplow; a design optimization module configured to perform simulation under a preset snow depth and running velocity to obtain train forces and snow removal paths under different snow depths and running velocities, and then generate a maximum velocity capable of satisfying an actual operation requirement under different snow depths based on a preset constraint condition; a design output module configured to output an optimal design parameter of the obstacle removal snowplow.

### BRIEF DESCRIPTION OF THE DRAWINGS

In order to more clearly illustrate technical solutions in embodiments of the present disclosure or the prior art, drawings required for descriptions of the embodiments or the prior art are briefly introduced below. It is apparent that the drawings described below are merely embodiments of the present disclosure, and those having ordinary skills in the art may obtain other drawings based on the provided drawings without creative efforts.

FIG. 1 is a schematic diagram illustrating shape parameters of an obstacle removal snowplow according to some embodiments of the present disclosure;

FIG. 2 is a schematic diagram illustrating a soft sphere model of two snow particles in mutual contact according to some embodiments of the present disclosure;

FIG. 3 is a schematic diagram illustrating a simplified processing of an inter-particle contact force by a soft sphere model according to some embodiments of the present disclosure;

FIG. 4 is a schematic diagram illustrating a low-temperature or normal-temperature snowfall simulation wind tunnel according to some embodiments of the present disclosure;

FIG. 5 is a schematic diagram illustrating experimental equipment according to some embodiments of the present disclosure;

FIG. 6 is a schematic diagram illustrating a wall snow accretion criterion according to some embodiments of the present disclosure;

FIG. 7 is a schematic diagram illustrating wedge models of two shapes according to some embodiments of the present disclosure;

FIG. 8 is a schematic diagram illustrating snow accretion of a wedge 1 according to some embodiments of the present disclosure;

FIG. 9 is a schematic diagram illustrating snow accretion of a wedge 2 according to some embodiments of the present disclosure;

FIG. 10 is a schematic diagram illustrating a computational domain for simulation according to some embodiments of the present disclosure;

FIG. 11 is a schematic diagram illustrating comparison of snow accretion results of a wedge 1 according to some embodiments of the present disclosure;

FIG. 12 is a schematic diagram illustrating cloud maps of a particle capture criterion and a flow field of a wedge 1 according to some embodiments of the present disclosure;

FIG. 13 is a schematic diagram illustrating comparison of snow accretion results of a wedge 2 according to some embodiments of the present disclosure;

FIG. 14 is a schematic diagram illustrating cloud maps of a particle capture criterion and a flow field of a wedge 2 according to some embodiments of the present disclosure;

FIG. 15 is a schematic diagram illustrating regression fitting of DEM simulation data according to some embodiments of the present disclosure;

FIG. 16 is a schematic diagram illustrating a relationship between a snow density and snow removal resistance according to some embodiments of the present disclosure;

FIG. 17 is a schematic diagram illustrating a relationship between a model width/reference width and snow removal resistance according to some embodiments of the present disclosure;

FIG. 18 is a schematic diagram illustrating a relationship between a snow removal depth and a resistance variation according to some embodiments of the present disclosure;

FIG. 19 is a schematic diagram illustrating simulation results of an open-type obstacle removal snowplow and a closed-type obstacle removal snowplow according to some embodiments of the present disclosure;

FIG. 20 is a schematic diagram illustrating simulation results of a whole vehicle model having an opening angle of 60°, an inclination angle of 45°, an angle of attack of 0°, and a suppression angle of 55° according to some embodiments of the present disclosure;

FIG. 21 is a schematic diagram illustrating locations of pressure measurement points according to some embodiments of the present disclosure;

FIG. 22 is a schematic diagram illustrating comparison of snow removal widths under different suppression angles according to some embodiments of the present disclosure;

FIG. 23 is a schematic diagram illustrating comparison of snow removal heights under different suppression angles according to some embodiments of the present disclosure;

FIG. 24 is a schematic diagram illustrating a numerical simulation computational domain according to some embodiments of the present disclosure; and

FIG. 25 is a schematic diagram illustrating an end height of a down pressing wing according to some embodiments of the present disclosure.

### DETAILED DESCRIPTION

The embodiments of the present disclosure are described in detail below. Examples of the embodiments are illustrated in the accompanying drawings. The same or similar reference numerals denote the same or similar elements or elements having the same or similar functions throughout. The embodiments described below with reference to the accompanying drawings are exemplary and are intended to explain the present disclosure, and should not be construed as limiting the present disclosure.

Considering railway snow accumulation caused by snowfall, a snow removal device is mounted at a train nose to assist the train in autonomously and rapidly removing snow during an initial stage of snow accumulation. For an obstacle removal snowplow (also referred to as a snowplow) of a train nose of an EMU, snow removal resistance generated during a snow removal process is a particular focus of the present disclosure, and the snow removal resistance is affected by multiple factors such as a running velocity, a shape of the obstacle removal snowplow, and a snow accumulation environment.

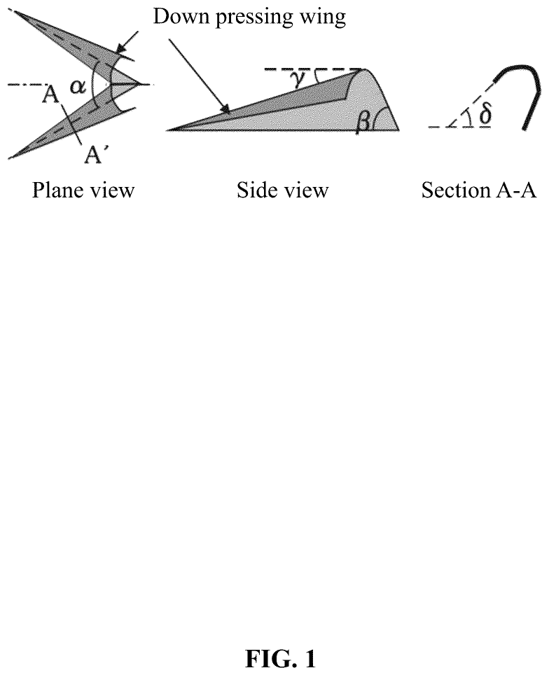

FIG. 1 is a schematic diagram illustrating shape parameters of an obstacle removal snowplow according to some embodiments of the present disclosure.

In some embodiments, a shape of an obstacle removal snowplow is mainly controlled by four shape parameters (also referred to as shape parameters), which are an opening angle α, an inclination angle β, an angle of attack γ, and a suppression angle δ, specifically referring to FIG. 1.

The present disclosure provides a simulation and optimization design system for an EMU obstacle removal snowplow based on multi-physical field coupling, used for executing a simulation and optimization design method for an EMU obstacle removal snowplow based on multi-physical field coupling, comprising the following modules.

A data acquisition module is configured to collect a snow environmental parameter of a target line. The snow environmental parameter includes snowfall data and snow accumulation data. In some embodiments, the data acquisition module may include at least one of a snow gauge, a snow depth sensor, and a snow characteristic analyzer disposed along a railway track.

A model processing module is configured to establish a soft sphere model of snow particles and determine a contact force between the snow particles using a Hertz-Mindlin with JKR Cohesion contact model.

A simulation module is configured to perform snow accretion simulation based on a wall snow accretion criterion using a discrete phase model, and then verify correctness of a snow removal resistance formula in the snow accretion simulation by comparing with preset snow removal experimental data.

A resistance determination module is configured to establish an obstacle removal snowplow model using a parametric modeling approach and introduce a shape parameter into a snow removal resistance formula based on a simulation result of snow accretion simulation to simplify a running resistance coefficient, and then evaluate snow removal performance of the obstacle removal snowplow under a preset shape parameter combination to determine the snow removal resistance formula of the obstacle removal snowplow.

An obstacle removal selection module is configured to add a train nose to the obstacle removal snowplow model to form a whole vehicle model and perform simulation based on the whole vehicle model, and then correct the snow removal resistance formula and generate a selection recommendation of the obstacle removal snowplow.

A design optimization module is configured to perform simulation under a preset snow depth and running velocity to obtain train forces and snow removal paths under different snow depths and running velocities, and then generate a maximum velocity capable of satisfying an actual operation requirement under different snow depths based on a preset constraint condition.

A design output module is configured to output an optimal design parameter of the obstacle removal snowplow.

In some embodiments, the simulation and optimization design system for the EMU obstacle removal snowplow based on multi-physical field coupling may include a processor and a memory. The processor may be configured to process data of at least one component of the simulation and optimization design system for the EMU obstacle removal snowplow based on multi-physical field coupling. The processor may include a central processing unit (CPU), an application specific integrated circuit (ASIC), a microprocessor, or the like, or any combination thereof.

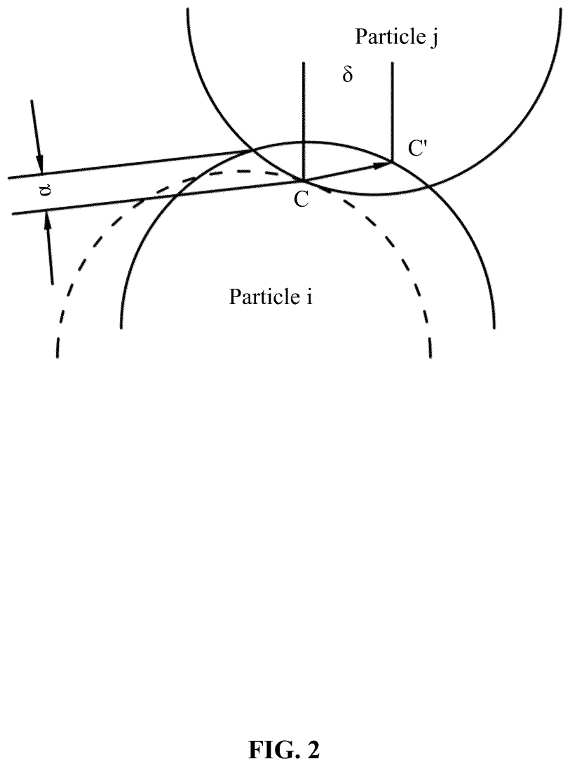

In some embodiments, the model processing module, the simulation module, the resistance determination module, the obstacle removal selection module, the design optimization module, and the design output module may be integrated on the processor. The processor may be communicatively connected to the data acquisition module. More descriptions regarding the simulation and optimization design system for the EMU obstacle removal snowplow based on multi-physical field coupling and a plurality of modules thereof may be found in FIGS. 2-25 and related descriptions thereof.

The memory may be configured to store data, instructions, and/or any other information. In some embodiments, the memory may include a mass memory, a removable memory, or the like, or any combination thereof.

In some embodiments, the processor adopts a discrete element numerical calculation approach to evaluate different combinations of the shape parameters of the obstacle removal snowplow, evaluate snow removal performance of the obstacle removal snowplow under the different parameter combinations, determine a snow removal resistance formula of the obstacle removal snowplow, and provide data support for traction checking. Numerical simulation calculation is not influenced by constraints of experimental conditions and may separately consider various phenomena or conditions, enabling in-depth research regarding mechanisms of the phenomena and obtaining quantitative results of nonlinear problems. During an engineering design process, the influence of variations of different parameters on an optimization objective can be obtained by through calculation, thereby facilitating comparison of multiple solutions. The present solution has characteristics such as a short research period and low cost and has advantages over various model tests and full-scale vehicle tests.

In some embodiments, the simulation and optimization design method for the EMU obstacle removal snowplow based on multi-physical field coupling is executed by the processor, comprising the following steps.

In S1, a snow environmental parameter of a target line is collected.

The target route may be a route along which an EMU travels. The target route is previously stored in the processor.

In some embodiments, the snow environmental parameter includes snowfall data, snow accumulation data, etc. The snowfall data includes a snowfall amount, a snowfall intensity, etc. The snow accumulation data includes a snow depth, a snow density, etc. The processor may obtain the snow environmental parameter through the data acquisition module.

In S2: a soft sphere model of snow particles is established and a contact force between the snow particles is determined using a Hertz-Mindlin with JKR Cohesion contact model.

Since a concentration of the snow particles (also referred to as particles) during a snow removal process of a train is relatively high and an error caused by excessive simplification of an actual physical process by hard sphere particles needs to be considered, the present disclosure adopts the soft sphere model (also referred to as the soft sphere model of snow particles) to perform simulation calculation.

In some embodiments, the soft sphere model simplifies a contact process between the particles into damped vibration of a spring oscillator, and an equation of motion of the damped vibration of the spring oscillator is expressed as mx+ci+kx=0, wherein x is a displacement deviating from an equilibrium position, m is a mass of the oscillator, and c and k are a spring damping coefficient and an elastic coefficient, respectively.

From the equation of motion, a restoring force applied to the snow particles is proportional to the displacement deviating from the equilibrium position, and viscous resistance applied to the snow particles is proportional to a velocity, with an opposite direction. Accordingly, energy of the spring oscillator gradually decays, and as damping increases, the spring oscillator exhibits underdamped vibration, critical damped vibration, and overdamped vibration, respectively.

FIG. 2 is a schematic diagram illustrating a soft sphere model of two snow particles in mutual contact according to some embodiments of the present disclosure.

In some embodiments, with reference to FIG. 2, a particle i contacts a particle j at a point C under an inertial force or an external force, and a dashed line represents a position of the particle i at the beginning of the contact. As relative motion between the two particles proceeds (the particle i moves from the point C to a point C′), surfaces of the two particles gradually deform and generate a contact force. The soft sphere model does not consider deformation details and only determines a normal overlap a and a tangential displacement 8, thereby determining the contact force between the two particles.

In some embodiments, the soft sphere model sets a spring, a damper, a slider, and a coupler between the particle i and the particle j. The coupler is used for determining a pairing relationship of particles in contact and does not introduce any force. In a tangential direction, in response to a tangential force exceeding a yield value, the two particles slide under a normal force and a friction force, and a sliding damper achieves this purpose.

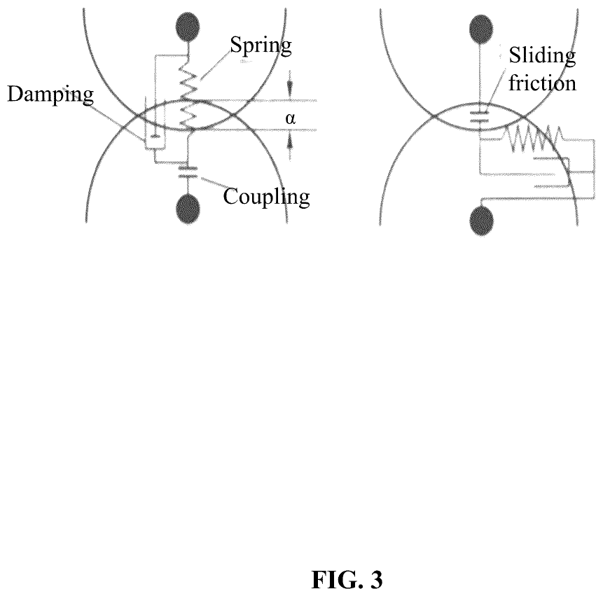

FIG. 3 is a schematic diagram illustrating simplified processing of an inter-particle contact force by a soft sphere model according to some embodiments of the present disclosure.

In some embodiments, the soft sphere model needs to introduce parameters such as the elastic coefficient k and the spring damping coefficient c to quantify effects of the spring, the damper, and the slider, referring to FIG. 3.

In some embodiments, the elastic coefficient and the spring damping coefficient introduced by the soft sphere model are related to parameters such as an elastic modulus and a Poisson's ratio of a particle material (snow particles), but the elastic coefficient and the spring damping coefficient are not directly measurable and need to be calibrated.

A normal elastic coefficient kₙ is determined according to Hertz contact theory:

$${k}_{n} = \frac{4}{3} {( \frac{1 - {v}_{i}^{2}}{{E}_{i}} + \frac{1 + {v}_{j}^{2}}{{E}_{j}} )}^{- 1} {( \frac{{R}_{i} + {R}_{j}}{{R}_{ij}} )}^{- 1 / 2} ,$$

wherein E and v are the elastic modulus and the Poisson's ratio of the particle material, respectively, and R is a particle radius, and subscripts i and j represent the particle i and the particle j in contact, respectively. In response to the particle i and the particle j belonging to a homogeneous material and having equal particle radii, kₙ is

$${k}_{n} = \frac{\sqrt{2 RE}}{3 ( 1 - {v}^{2} )} .$$

A tangential elastic coefficient kₜ is expressed as:

$${k}_{t} = 8 {{α}^{- 1 / 2} ( \frac{1 - {v}_{i}^{2}}{{G}_{i}} + \frac{1 + {v}_{j}^{2}}{{G}_{j}} )}^{- 1} {( \frac{{R}_{i} + {R}_{j}}{{R}_{i j}} )}^{- 1 / 2} ,$$

wherein α is a normal overlap, Gᵢ and Gⱼ are a shear modulus of the particle i and a shear modulus of the particle j, respectively. In response to the particle i and the particle j belonging to a homogeneous material and having equal particle radii,

$${k}_{t} is {k}_{t} = \frac{2 \sqrt{2 RG}}{3 ( 1 - {v}^{2} )} {α}^{- 1 / 2} .$$

In some embodiments, during a contact process between the particles, kₙ and kₜ are related to the normal overlap and need to be calculated in real time according to the contact process. However, the amount of calculation is extremely large. For calculation convenience, the soft sphere model usually assumes that the elastic coefficient, the spring damping coefficient, and other parameters remain constant during the entire contact process ignoring details such as loading history and deformation.

In some embodiments, in response to a spring oscillator with a mass m being in a critical damping state, mechanical energy decays at a fastest velocity, and in this case, the normal spring damping coefficient cₙ and the tangential spring damping coefficient cₜ are respectively expressed as:

$${c}_{n} = 2 \sqrt{m {k}_{n}} , {c}_{t} = 2 \sqrt{m {k}_{t}} ,$$

or, the normal damping coefficient is coupled with a restitution coefficient e:

$${c}_{n} = \frac{2 ln e}{\sqrt{{π}^{2} + ln e}} \sqrt{m {k}_{n}}$$

wherein e is determined by an experiment.

In some embodiments, a JKR normal force is determined based on an overlap δ, an interaction parameter, and a surface energy γ:

$${F}_{JKR} = - 4 \sqrt{π γ {E}^{*}} {a}^{\frac{3}{2}} + \frac{4 {E}^{*}}{3 {R}^{*}} {a}^{3} , δ = \frac{{a}^{2}}{{R}^{*}} - \sqrt{\frac{4 π γ a}{{E}^{*}}} ,$$

wherein E* is an equivalent Young's modulus, and R* is an equivalent radius.

The expression of a damping force

$${F}_{n}^{d} is : {F}_{n}^{d} = - 2 \sqrt{\frac{5}{6}} β \sqrt{{S}_{n} {m}^{*}} {v}_{n}^{\overline{rel}} , wherein {m}^{*} = {( \frac{1}{{m}_{1}} + \frac{1}{{m}_{i}} )}^{- 1}$$

is an equivalent mass,

$${v}_{n}^{\overline{rel}}$$

is a normal component of relative velocity, and expressions of β and Sₙ are:

$$β = \frac{ln e}{\sqrt{{π}^{2} + ln e}} , {S}_{n} = 2 {E}^{*} \sqrt{{R}^{*} {δ}_{n}} .$$

The expression of a tangential force

$${F}_{t}^{d} is : {F}_{t}^{d} = - 2 \sqrt{\frac{5}{6}} β \sqrt{{S}_{t} {m}^{*}} {v}_{t}^{\overline{rel}} ,$$

wherein Sₜ is a tangential overlap.

Sₜ=8\sqrt{G*R*δₙ,} G*is the equivalent shear modulus,

$${v}_{t}^{\overline{rel}}$$

is the tangential component of relative velocity. The tangential force is limited by Coulomb friction μₛFₙ, wherein μₛ is a static friction coefficient, and rolling friction applies a moment on a contact surface: τᵢ=−μᵣ FₙRᵢωᵢ. μᵣ is a rolling friction coefficient, Rᵢ is a distance from a contact point to a center of mass, and ωᵢ is a unit angular velocity vector of an object at the contact point.

A maximum spacing with non-zero cohesion between particles is calculated by:

$${δ}_{c} = \frac{{a}^{2}}{{R}^{*}} - \sqrt{\frac{4 π γ a}{{E}^{*}}} , {a}_{c} = {[ \frac{9 π γ {R}^{* 2}}{2 {E}^{*}} ( \frac{3}{4} - \frac{1}{\sqrt{2}} ) ]}^{\frac{1}{3}} ,$$

wherein when δ<δ_{c}, the model returns 0.

When the particles are not in actual contact and the spacing is less than δ_{c}, the cohesion reaches a maximum value, and thus, the maximum cohesion is:

$${F}_{pullout} = - \frac{3}{2} π γ {R}^{*} .$$

Accordingly, a JRK friction model provides a larger friction force when the cohesion component of the contact force is larger. The JKR friction model is designed for fine or dry particles and may also be used for simulating wet particles. The force required to separate two particles depends on a liquid surface tension γₛ and a contact angle. For moist snow particles, the liquid surface tension γₛ may be preset based on historical experience, e.g., 0.1 to 0.3 N/m, etc.

In some embodiments, during calculation of the contact force between the snow particles, the processor may automatically determine, at each preset duration, a snow particle pair and a snow particle-snowplow surface pair which are in contact. The processor may generate, based on the contact model, the normal contact force, the tangential friction force, and the cohesion (e.g., JKR cohesion) of the snow particle pair and the snow particle-snowplow surface pair, and may update positions and velocities of a plurality of snow particles based on the normal contact force, the tangential friction force, the cohesion, and a preset rule.

The preset duration may be preset based on historical experience.

The snow particle pair refers to two snow particles that are in physical contact.

The snow particle-snowplow surface pair refers to a snow particle that is in contact with a surface of the snowplow.

In some embodiments, after the processor identifies the snow particle pair and the snow particle-snowplow surface pair that are in contact, the processor performs the following calculation procedure for each snow particle pair or snow particle-snowplow surface pair based on the Hertz-Mindlin with JKR Cohesion contact model:

The processor calls a contact model function and inputs parameters such as positions, velocities, overlaps, and material properties of the snow particle pair (or the snow particle and the snowplow). The processor calculates a normal contact force (simulating elastic recovery) based on a contact depth and a normal elastic coefficient of the snow particle pair (or the snow particle and the snowplow). The processor calculates a tangential friction force based on a relative sliding amount, a tangential elastic coefficient, and a friction coefficient of the snow particle pair (or the snow particle and the snowplow). The processor calculates JKR cohesion based on a surface energy, a contact radius, and a contact adhesion theory of the snow particle pair (or the snow particle and the snowplow).

In some embodiments, the processor generates the normal contact force, the tangential friction force, and the JKR cohesion of the snow particle pair and the snow particle-snowplow surface pair by executing the above calculation procedure.

In some embodiments, the preset rule may include Newton's second law, etc.

In some embodiments, for each snow particle in the snow particle pair or the snow particle-snowplow surface pair, the processor may collect all contact forces exerted on the snow particle, including the contact forces between the snow particles and the contact forces between the snow particle and the surface of the snowplow, calculate an acceleration vector of the snow particle based on the Newton's second law, and update the position and the velocity of the snow particle through velocity-displacement integration.

Some embodiments of the present disclosure realize automatic identification and mechanical solving of interactions between the snow particles and interactions between the snow particle-snowplow surfaces, and reproduce collision, accumulation, and adhesion behaviors of snow in the processor with a high spatiotemporal resolution, providing a physical basis for simulation.

In S3: snow accretion simulation is performed based on a wall snow accretion criterion using a discrete phase model, and correctness of a snow removal resistance formula in the snow accretion simulation is verified by comparing with preset snow removal experimental data.

In some embodiments, a Lagrangian approach represented by the discrete phase model is widely applied to wall snow accretion simulation research.

In some embodiments, a continuity equation and a momentum conservation equation of the discrete phase model are respectively expressed as:

$$\frac{\partial ( {α}_{f} {ρ}_{f} )}{\partial t} + ∇ \cdot ( {ρ}_{f} {α}_{f} u ) = 0 , and$$

$$\frac{\partial ( {α}_{f} {ρ}_{f} u )}{\partial t} + ∇ \cdot ( {ρ}_{f} {α}_{f} u u ) = - {α}_{f} ∇ P - {F}_{f - p} + {α}_{f} ∇ \cdot τ + {α}_{f} {ρ}_{f} g ,$$

wherein ρ_{f}, u, and P are a density, a velocity, and a pressure of a fluid, respectively, t is time, g is gravity acceleration, and α_{f} is fluid volume fraction.

$${α}_{f} = 1 - {V}_{p} / {V}_{c} ,$$

wherein V_{c} and Vₚ are a total volume of a control volume unit and a particle volume, respectively, F_{f-p} is a force between an air phase and a snow phase and is mainly a particle drag force F_{drag}, and τ is a fluid viscous stress tensor.

$$τ = - \frac{2}{3} ( {μ}_{f} ∇ \cdot u ) I + {μ}_{f} [ ( ∇ u ) + {( ∇ u )}^{- 1} ] ,$$

wherein I is a unit tensor and μ_{f} is a fluid viscosity including a kinematic viscosity and a turbulent viscosity.

For the snow phase, the snow particles are regarded as spheres, and a force equilibrium equation of the snow particles is expressed as:

$${m}_{p} \frac{{du}_{p}}{dt} = {F}_{drag} + \frac{{m}_{p} ( {ρ}_{p} - {ρ}_{f} ) g}{{ρ}_{p}} + F ,$$

wherein mₚ, uₚ, and ρₚ are a mass, a velocity, and a density of the snow particles, respectively, and F is an additional external field

$${F}_{drag} = \frac{18 {μ}_{f}}{{ρ}_{d} {d}_{p}^{2}} \frac{{C}_{D} {R}_{e , p}}{24} ( {u}_{f} - {u}_{p} ) ,$$

wherein dₚ is a snow particle diameter, C_{D} is a particle drag coefficient, which is determined based on a smooth sphere model by a set of empirical constants a₁, a₂, and a₃ determined by a range of a particle Reynolds number R_{e,p},

$${C}_{D} = {a}_{1} + \frac{{a}_{2}}{{R}_{e , p}} + \frac{{a}_{3}}{{R}_{e , p}^{2}} .$$

A particle trajectory is determined:

$$\frac{dx}{dt} = {u}_{p} ,$$

and the differential equation is solved along each coordinate direction to obtain a trajectory of the discrete phase.

Accordingly, a control equation of the fluid (air) phase is solved using a conventional semi-implicit method for pressure linked equations (SIMPLE), and the equation of motion of the particles in the flow field is solved based on explicit time integration.

In some embodiments, in response to the snow particles impacting a wall surface of the obstacle removal snowplow, whether the snow particles adhere to the wall surface and stably accumulate is determined based on a suitable wall snow accretion criterion. A post-collision motion between the snow particles and the wall surface is key to determine snow accretion, and the post-collision motion mainly depends on collision characteristics between the snow particles and the wall surface and a flow field effect of the wall surface. From an energy perspective, the collision between the snow particles and the wall surface is an inelastic collision, and a degree of kinetic energy loss after the collision determines an adhesion behavior or a rebound behavior. However, the loss of kinetic energy of the snow particles (consumption or conversion into cohesive internal energy) is related to many complex factors, including a crystal type of the snow particles, a moisture content characteristic of the snow particles, and a viscosity between crystals of the snow particles, and thus is not described only by a traditional restitution coefficient or a splash function. In addition, whether the snow particles stably or continuously adhere to the wall surface under the action of a flow field is also related to a wall-surface shear stress (a friction velocity). In response to a wall-surface friction velocity u* being greater than a threshold friction velocity u*t, the snow particles on the wall surface undergo erosion and thus fail to stably adhere to the wall surface. The threshold friction velocity may be preset.

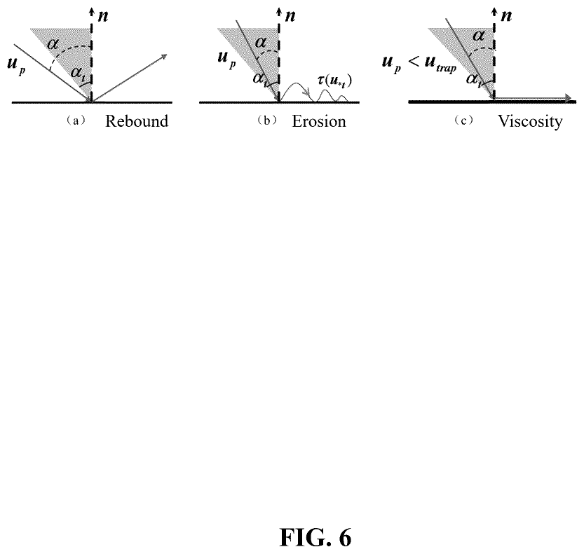

FIG. 6 is a schematic diagram illustrating a wall snow accretion criterion according to some embodiments of the present disclosure. In FIG. 6(a), the snow particles rebound from the wall surface. In FIG. 6(b), the snow particles erode the wall surface. In FIG. 6(c), the snow particles adhere to the wall surface due to a viscous force.

In some embodiments, referring to FIG. 6, the wall snow accretion criterion includes the following three items.
(1) In response to an incident angle α being less than a capture angle αₜ, the snow particles are captured by the wall surface.
(2) In response to a local friction velocity being less than a preset threshold friction velocity, the snow particles are not carried away by wind, resulting in accumulation. The preset threshold friction velocity may be preset based on historical experience.
(3) In response to a particle collision velocity up being less than a critical capture velocityuₜᵣₐₚ, a viscous force of the wall surface on the snow particles is relatively large, and the snow particles are captured.

In some embodiments, in response to the snow particles satisfying the above three wall snow accretion criteria, the snow particles are captured by the wall surface and stably accumulated on the wall surface to achieve snow accretion on the wall surface.

In some embodiments, the processor may determine the capture angle αₜ and the critical capture velocity uₜᵣₐₚ based on physical property data of the snow particles, wall property data of the wall surface, and a wall temperature.

The physical property data refers to data that characterizes physical states and structural features of the snow particles. In some embodiments, the physical property data may include a moisture content, an average particle size, and snow crystal morphology of the snow particles.

The moisture content refers to a proportion of water in the snow particles. The snow crystal morphology refers to a geometric structural type of the snow particles, including at least one of hexagonal or columnar forms.

In some embodiments, the processor may acquire the moisture content of the snow particles through a moisture detection device (e.g. a near-infrared humidity sensor) deployed on the target path. The processor may capture images of the snow particles using an image capture device (e.g., a macro camera) and identify the morphology and fit the size of the snow particles using an image recognition algorithm (e.g., an image segmentation algorithm) to obtain the average particle size and the snow crystal morphology of the snow particles.

The wall property data refers to data that characterizes the physical properties of the surface of the snowplow. In some embodiments, the wall property data may include a material and roughness of the wall surface of the snowplow. The material may include aluminum alloy or stainless steel. The wall property data of the snowplow wall surface may be determined by factory manufacturing parameters and prestored in the processor.

The wall temperature refers to a surface temperature of the wall surface of the snowplow during train operation. In some embodiments, the wall temperature in the snow accretion simulation may be preset based on historical experience. In model experiments and actual applications, the processor may obtain the wall temperature via a temperature sensor provided on the wall surface.

In some embodiments, the processor may determine the capture angle and the critical capture velocity based on the physical property data, the wall property data, and the wall temperature by querying a preset table.

The preset table includes a plurality of correspondence relationships, and each correspondence relationship includes a corresponding relationship between a set of physical property data, wall property data and wall temperature, and a set of capture angle and critical capture velocity.

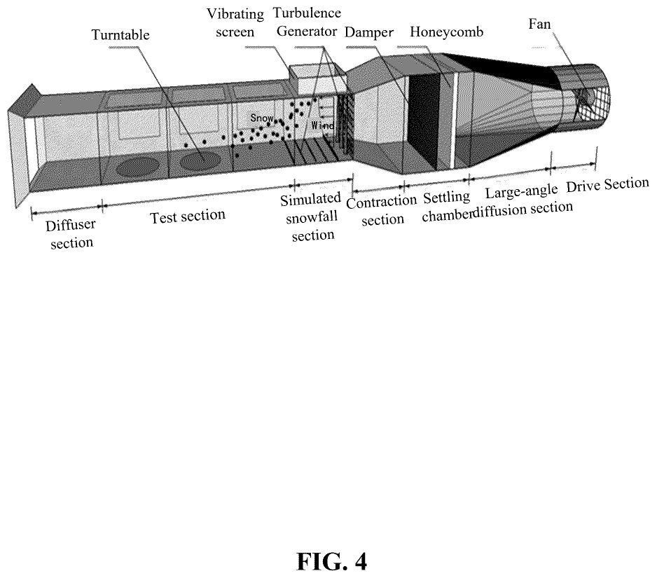

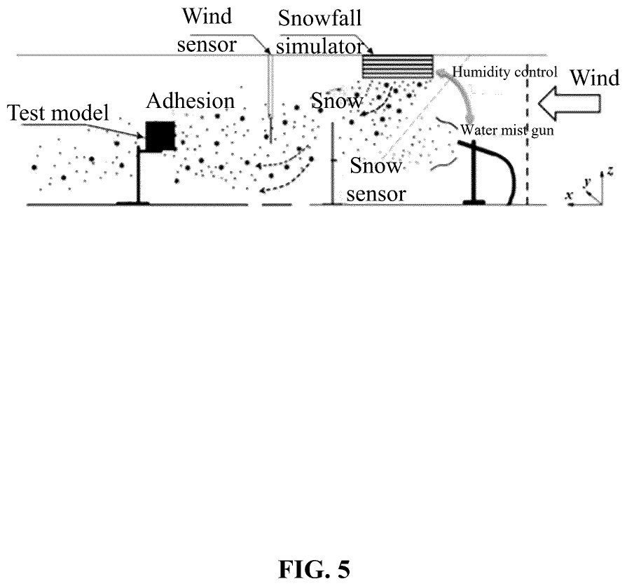

In some embodiments, the preset table may be constructed based on historical wind tunnel test records corresponding to combinations of a plurality of physical property data and wall property data. More descriptions regarding the wind tunnel tests and test equipment may be found elsewhere in the present disclosure (e.g., FIGS. 4 and 5 and related descriptions thereof).

Merely by way of example, the processor may use a maximum incident angle at which the snow particles collide with the wall surface and adhere as the capture angle, and a maximum impact velocity at which the snow particles adhere as the critical capture velocity.

It can be understood that the higher the moisture content of the snow particles, the stronger the viscosity of the snow particles, making the snow particles more prone to deformation and adhesion to the wall surface. The snow particles exhibit good adhesion ability when the average particle size of the snow particles is moderate. When the average particle size of the snow particles is too small, the kinetic energy of the snow particles is low and the contact area of the snow particles is insufficient. When the average particle size of the snow particles is too large, the kinetic energy of the snow particles is excessive and rebound easily occurs. The more complex the snow crystal morphology of the snow particles, the looser the structure of the snow particles, and the more prone to uneven force distribution and rotational rebound, resulting in a decrease in adhesion. The material of the wall surface affects thermal conductivity and surface energy; a material with high thermal conductivity softens the snow particles and facilitates adhesion of the snow particles, and a material with high surface energy enhances the adhesion force. A rougher wall surface provides a larger count of microstructural hindrance points and facilitates adhesion of the snow particles. A higher wall temperature may cause local softening on the surface of the snow particles and facilitate adhesion of the snow particles.

In some embodiments, the processor may determine the capture angle αₜ and the critical capture velocity uₜᵣₐₚ based on the physical property data of the snow particles, the wall property data of the wall surface, the wall temperature, an environmental temperature, and an environmental wind velocity through a parameter determination model, the parameter determination model being a machine learning model.

The environmental temperature refers to an air temperature in an environment where the snowplow is located. In some embodiments, the higher the environmental temperature, the easier the surface of the snow particles becomes soft and deformed, and the more thorough the contact with the wall surface, thereby increasing the capture angle and the critical capture velocity.

The environmental wind velocity refers to an airflow velocity in an environment where the snowplow is located. In some embodiments, the higher the environmental wind velocity, the greater the average velocity of the snow particles, the higher the incident kinetic energy, and the particles are less likely to adhere, resulting in a decrease in the capture angle and the critical capture velocity.

In some embodiments, the environmental temperature and the environmental wind velocity may be preset based on historical experience. In model tests and actual applications, the processor may obtain the environmental temperature and the environmental wind velocity through a temperature sensor and a wind velocity sensor provided at a roadside of the target path.

In some embodiments, the parameter determination model may be a machine learning model, such as any one of a neural network (CNN) model, a recurrent neural network (RNN) model, or the like, or any combination thereof.

In some embodiments, the processor may train the parameter determination model using a plurality of training samples with labels. The training samples include sample physical property data of sample snow particles, sample wall property data of the wall surface, a sample wall temperature, a sample environmental temperature, and a sample environmental wind velocity. The labels include the capture angle and the critical capture velocity corresponding to the training samples.

In some embodiments, the processor may determine the training samples and the labels based on a plurality of historical wind tunnel experiment records. For example, the processor may regard the physical property data of the sample snow particles, the sample wall property data of the wall surface, the sample wall temperature, the sample environmental temperature, and the sample environmental wind velocity used in each historical wind tunnel experiment record as the training samples, and may regard the capture angle and the critical capture velocity corresponding to each historical wind tunnel experiment record as the labels of the training samples.

In some embodiments, the processor may input the plurality of training samples with the labels into an initial parameter determination model, construct a loss function through the labels and a result of the initial parameter determination model, and iteratively update parameters of the initial parameter determination model through gradient descent or other approaches based on the loss function. When a preset training condition is satisfied, model training is completed, and a trained parameter determination model is obtained. The preset training condition may be convergence of the loss function or a count of iterations reaching a threshold value, etc.

In some embodiments of the present disclosure, by introducing the parameter determination model containing environmental factors, a variation trend of the capture angle and the critical capture velocity under multi-parameter coupling is fitted, enabling the processor to achieve higher simulation accuracy, thereby accurately reflecting the influence of complex snow conditions and wind conditions on the snow accretion behavior, and improving authenticity of the simulation of the model.

In some embodiments of the present disclosure, the capture angle and the critical capture velocity are determined based on data such as physical property attributes of the snow particles and the wall property data of the wall surface by looking up the table, so that the capture angle and the critical capture velocity under different snow conditions and wall surface conditions can be rapidly determined, providing reasonable and reliable determination bases for snow accretion simulation, and improving authenticity of simulation results with respect to real snow accretion scenarios.

Merely by way of example, surface snow accretion tests were performed on different wedges in the present disclosure to investigate forms of snow distribution on surfaces of the different wedges. Meanwhile, numerical simulation research of the tests is performed using a numerical simulation approach.

FIG. 4 is a schematic diagram illustrating a low-temperature or normal-temperature snowfall simulation wind tunnel according to some embodiments of the present disclosure.

FIG. 5 is a schematic diagram illustrating experimental equipment according to some embodiments of the present disclosure.

In some embodiments, the tests were conducted in a low-temperature or normal-temperature snowfall simulation wind tunnel with reference to FIG. 4 and FIG. 5. The wind tunnel is located in an enclosed environment and is of a direct current type, has a total length of 14 m, a test section length of 6 m, a cross-sectional side length of 1.2, and a maximum experimental wind velocity of 10 m/s, and can conduct experimental research using real snow based on low-temperature (such as below −20° C.) and snowy conditions in some regions.

In some embodiments, the test equipment may mainly include four parts: a wind tunnel equipment system, a snowfall system, a model system, a data acquisition system, etc. The wind tunnel equipment system may include components such as a fan and a wind tunnel chamber. The snowfall system (also referred to as a snowfall simulator) may include a vibrating screen for dispersing snow particles, a water mist gun, etc. The model system may include a test model (i.e., a wedge model), a rigid support, etc. The data acquisition system may include an anemometer, a scanner, a snow sensor, etc.

In some embodiments, an overall approach of the snow accretion tests is to use a uniform and stable wind field inflow to simulate a stable static flow field of natural wind velocity and to transport the snow particles falling from the vibrating screen toward the surface of the test model. During this process, the water mist gun emits fine and uniform water mist. The water mist combines with the snow particles in the wind field to form a thin water film on surfaces of the snow particles, thereby simulating a non-negligible adhesion force caused by the moisture content of the snow particles under actual conditions. The water mist further combines with the snow particles during the snow blowing process, enabling the snow particles to possess a certain moisture content and finally adhere to the surface of the test model.

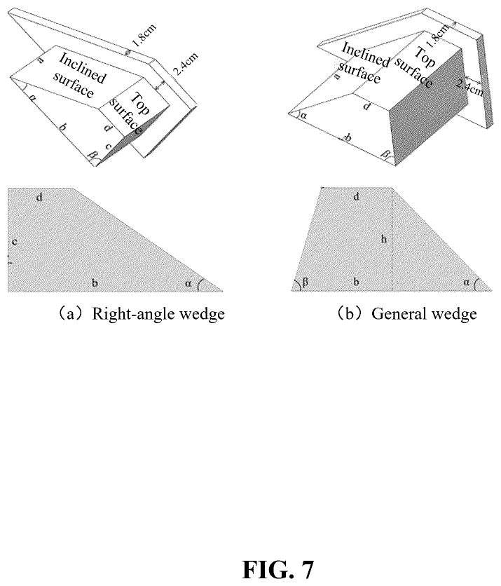

FIG. 7 is a schematic diagram illustrating wedge models of two shapes according to some embodiments of the present disclosure.

In some embodiments, referring to FIG. 7, the wedge model is divided into the following two types: a right-angle wedge shown in FIG. 7(a) (referred to as a wedge 1) and a general wedge shown in FIG. 7(b) (referred to as a wedge 2).

In some embodiments, the snow particles in the experiment are natural snowfall, with a snow density of 320 kg/m³ and an average particle size of 0.8 mm. A test temperature is below −25°, a snow conveying flux is 3.5 kg/m²·h, the four test models are all 0° vertically facing the wind, the wind velocity is 5 m/s, and snow blowing time is 10 min.

Snow accretion results of the wedge 1 are as follows: a mass before the snow accretion is 1850 g, a mass after the snow accretion is 1970 g, and a snow accumulation mass is 120 g.

In some embodiments, after the snow accretion is completed, scanning measurement is performed using the scanner. Distorted points appearing in the measurement process are corrected or deleted after scanning, and preliminarily processed point cloud data is then interpolated. After the interpolation processing, shape cloud maps of an original model and a model surface after the snow accretion are obtained. The two sets of data before and after the snow accretion are then processed by subtraction to obtain a snow depth on the model surface, and a snow accumulation depth cloud map is subsequently generated.

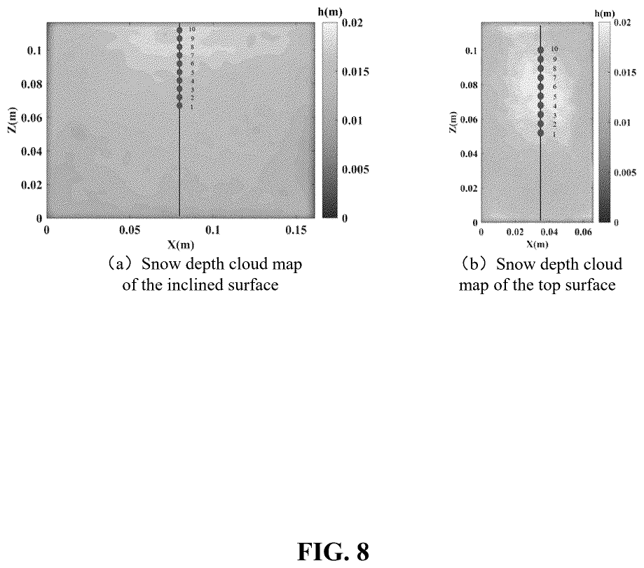

FIG. 8 is a schematic diagram illustrating snow accretion of a wedge 1 according to some embodiments of the present disclosure. FIG. 8(a) is an inclined-surface snow depth cloud map, and FIG. 8(b) is a top-surface snow depth cloud map.

In some embodiments, referring to FIG. 8, snow accumulation on a top surface and snow accumulation on an inclined surface are both concentrated in an upper-middle region. A peak snow depth of the top surface is 1.07 times an extreme snow depth of the inclined surface. However, the snow accumulation on the top surface shows a trend of increasing first and then decreasing as the distance from the top increases. The snow accumulation on the inclined surface shows a trend of decreasing as the distance from the top increases, and the snow accumulation tends to extend toward a lower right corner.

The snow accretion results of the wedge 2 are as follows: a mass before the snow accretion is 3040 g, a mass after the snow accretion is 3195 g, and the snow accumulation mass is 155 g.

In some embodiments, after the snow accretion is completed, the measurement is performed using the scanner to obtain final point cloud data after the snow accretion. Distorted points appearing in the measurement process are corrected or deleted after the scanning, and the preliminarily processed point cloud data is then interpolated. The two sets of data before and after the snow accretion are subsequently processed by subtraction to obtain a snow depth on the model surface after the snow accretion, and a snow accumulation depth cloud map is generated. From the overall snow accretion cloud map, an inclined surface with an inclination angle of 72° shows only a few scattered snow particles attached and may be neglected. Thereafter, only snow accumulation distributions on the top surface and the inclined surface with an inclination angle of 45° are analyzed.

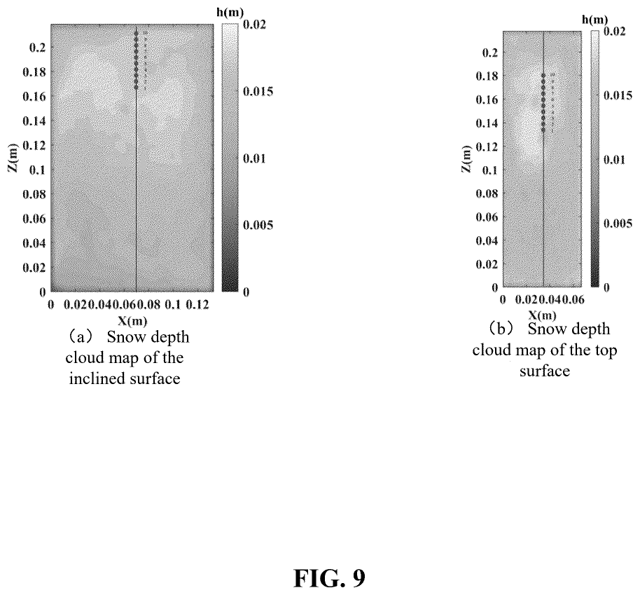

FIG. 9 is a schematic diagram illustrating snow accretion of a wedge 2 according to some embodiments of the present disclosure. FIG. 9A is a snow depth cloud map of the inclined surface, and FIG. 9B is a snow depth cloud map of the top surface.

In some embodiments, referring to FIG. 9, the snow accumulation on the top surface and the snow accumulation on the inclined surface are both concentrated in an upper middle region. A peak snow depth of the top surface is 1.05 times an extreme snow depth of the inclined surface and appears in a left middle region. The snow accumulation on the top surface shows a trend of first increasing and then decreasing as the distance from the top increases. The snow accumulation on the inclined surface shows a trend of decreasing as the distance from the top increases, and a symmetric peak region of snow accumulation appears in the upper middle region. The snow accumulation tends to extend toward a lower right corner.

In S4: an obstacle removal snowplow model is established using a parametric modeling approach, a shape parameter is introduced into the snow removal resistance formula based on a simulation result of the snow accretion simulation to simplify a running resistance coefficient, snow removal performance of the obstacle removal snowplow under a preset shape parameter combination is evaluated, and the snow removal resistance formula of the obstacle removal snowplow is determined.

In some embodiments, the numerical simulation is performed using a discrete phase model. Based on the test conditions, a numerical simulation model having the same size and the same boundaries as the test conditions is established during the numerical simulation.

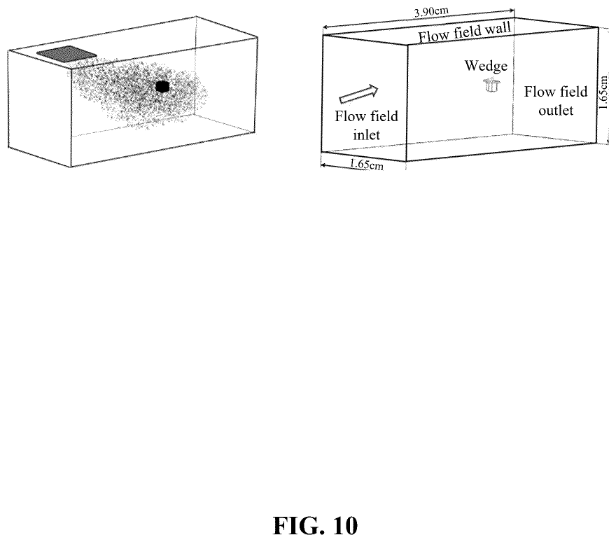

FIG. 10 is a schematic diagram illustrating a computational domain for simulation according to some embodiments of the present disclosure.

In some embodiments, referring to FIG. 10, a finite element model uses a computational domain with the size of 3.9 m×1.65 m×1.65 m. A particle introduction position is set to be the same as a position of the vibrating screen in the experiment, and a particle introduction plane has the size of 0.74 m×0.74 m.

In some embodiments, the simulation model uses a structured mesh. A minimum mesh size is 0.005 m, and a mesh count is 4 million. An inflow boundary of the computational domain is set as a velocity inlet with an inflow velocity of 5 m/s. An outlet of the computational domain is set as a steady outflow boundary. The surface of the model is set as a no sliding boundary. Side boundaries and a bottom surface of the computational domain are set as symmetric boundaries. The specific flow field boundary conditions are listed in the following table.

| | Flow field | |
|---|---|---|
| | boundary | |
| Boundary region | condition | Remarks |
| Fluid inlet | Velocity inlet | Wind velocity: 5 m/s |
| Fluid outlet | Steady outflow | — |
| Wedge | No sliding wall | Friction coefficient: 0.5 |
| Side surface, top surface, | Symmetry | — |
| and bottom surface of the | | |
| computational domain | | |

In some embodiments, the fluid is regarded as a continuous phase in the simulation, and a Realizable k-& turbulence model is selected for flow field simulation. Based on the snow accretion test of the wedge, a uniform and steady flow field is adopted, and an inlet wind velocity is set to 5 m/s. An air density is set as 1.255 kg/m³, and a viscosity is set as 1.78×10⁻⁵. A steady-state solution is performed using the SIMPLE algorithm until convergence is achieved. A second-order upwind scheme is used for a pressure term and a momentum term, a first-order implicit scheme is used for a time term, and a first-order upwind scheme is used for a turbulent kinetic energy and a turbulent dissipation rate.

In some embodiments, the snow particles are treated as a discrete phase in the simulation, and physical parameters of the snow particles are determined based on actual snowfall measurement, with a skeleton density of 320 kg/m³. A Rosin-Rammler distribution is considered, and a maximum particle size and a minimum particle size of the snow particles are set to 0.9 mm and 0.7 mm, respectively, with the average particle size of 0.8 mm. The boundary conditions for the discrete phase are set as follows: the fluid inlet and the fluid outlet are set as escape boundaries; the side surfaces, the top surface, and the bottom surface of the computational domain are set as rebound boundaries; and the wedge model is set as a customized wall embedded with the wall snow accretion criterion to determine the adhesion behavior of the snow particles after colliding with the wall surface. In the customized capture, rebound motion of the snow particles not satisfying the wall snow accretion criterion is considered, a tangential velocity restitution coefficient (a ratio of a tangential velocity after rebound to a tangential velocity before rebound) is set to 0.7, a normal velocity restitution coefficient is set to 0.1, and a random walk model is enabled in the simulation.

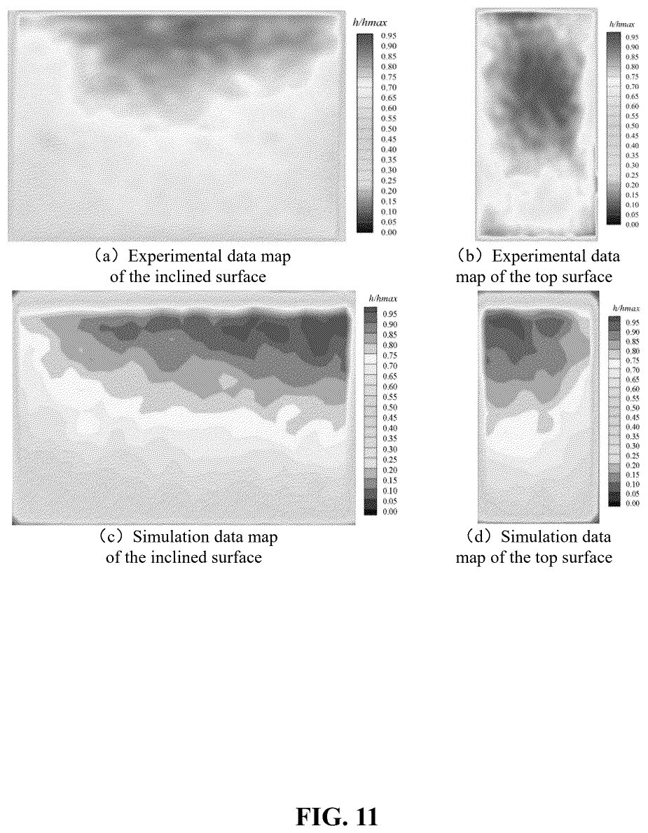

FIG. 11 is a schematic diagram illustrating comparison of snow accretion results of a wedge 1 according to some embodiments of the present disclosure. FIG. 11(a) is an experimental data map of an inclined surface, FIG. 11(b) is an experimental data map of a top surface, FIG. 11(c) is a simulation data map of an inclined surface, and FIG. 11(d) is a simulation data map of a top surface.

In some embodiments, referring to FIG. 11, the comparison of the snow accretion cloud maps of the wedge 1 shows that compared with the experimental results, the overall distribution of the cloud maps is similar. The cloud maps exhibit a trend of greater snow accretion in an upper region and less snow accretion in a lower region. The peak values of the snow accumulation on the top surface in the experimental results and the simulation results are both located in an upper middle region. In the experimental results, the peak value of the snow accumulation on the inclined surface appears in a middle region, while in the simulation results, the peak value of the snow accumulation on the inclined surface appears in an upper right region. The snow accumulation exhibits a trend of decreasing from the upper right region toward the lower left region. A deviation is observed, but agrees with the experimental results overall.

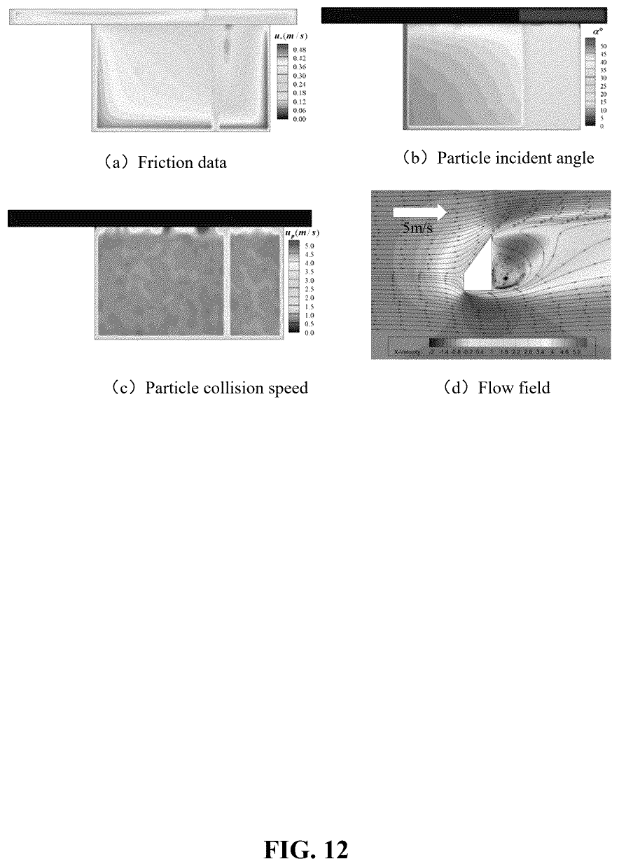

FIG. 12 is a schematic diagram illustrating cloud maps of a particle capture criterion and a flow field of a wedge 1 according to some embodiments of the present disclosure. FIG. 12(a) illustrates friction data, FIG. 12(b) illustrates a particle incident angle, FIG. 12(c) illustrates a particle collision velocity, and FIG. 12(d) illustrates a flow field.

In some embodiments, referring to FIG. 12, the particle incident angle and the friction velocity on the inclined surface increase along a diagonal direction toward the lower left region. The particle incident angle on the top surface is relatively small and exhibits a trend of increasing from the upper region toward the lower region. The region having a relatively low friction velocity appears in the upper region of the top surface, mainly due to flow separation around a bluff body, resulting in a decrease in wind velocity and forming a particle accumulation region. In the middle regions of the top surface and the inclined surface, the particle collision velocity is relatively low, and particles tend to accumulate, which agrees with the experimental results.

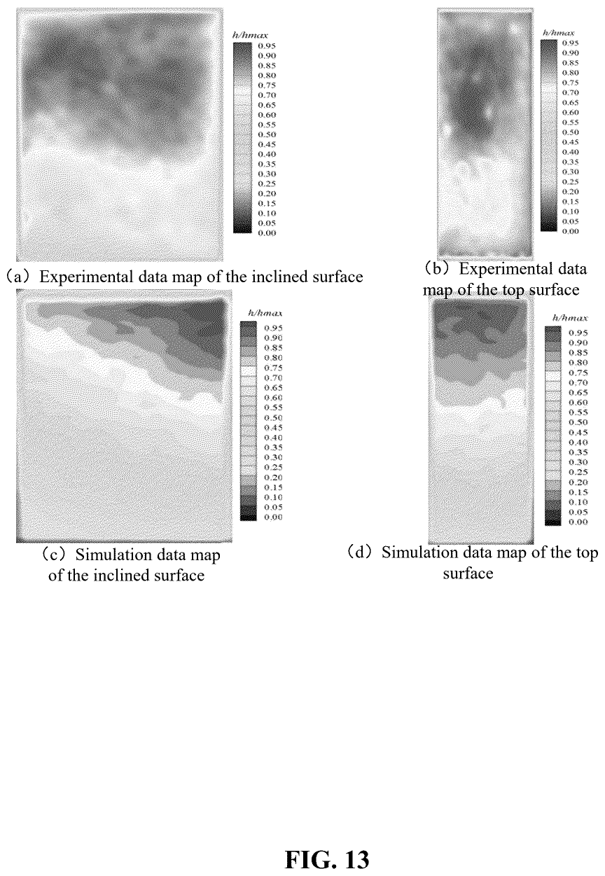

FIG. 13 is a schematic diagram illustrating comparison of snow accretion results of a wedge 2 according to some embodiments of the present disclosure. FIG. 13(a) is an experimental data map of an inclined surface, FIG. 13(b) is an experimental data map of a top surface, FIG. 13(c) is a simulation data map of an inclined surface, and FIG. 13(d) is a simulation data map of a top surface.

In some embodiments, referring to FIG. 13, the comparison of the snow accretion cloud maps of the wedge 2 shows that compared with the experimental results, the overall distribution of the cloud maps is similar and exhibits the trend of greater snow accretion in an upper region and less snow accretion in a lower region. An overall amount of snow accumulation in the simulation results is less than that in the experimental results. The peak value of the snow accumulation on the top surface in the experimental results appears in a left region of the upper middle region, while the peak value of the snow accumulation on the top surface in the simulation results appears in the upper region. In the experimental results, the peak value of the snow accumulation on the inclined surface appears in the upper middle region, while the peak value of the snow accumulation on the inclined surface in the simulation results appears in the upper right region. The snow accumulation exhibits a trend of decreasing from the upper right region toward the lower left region.

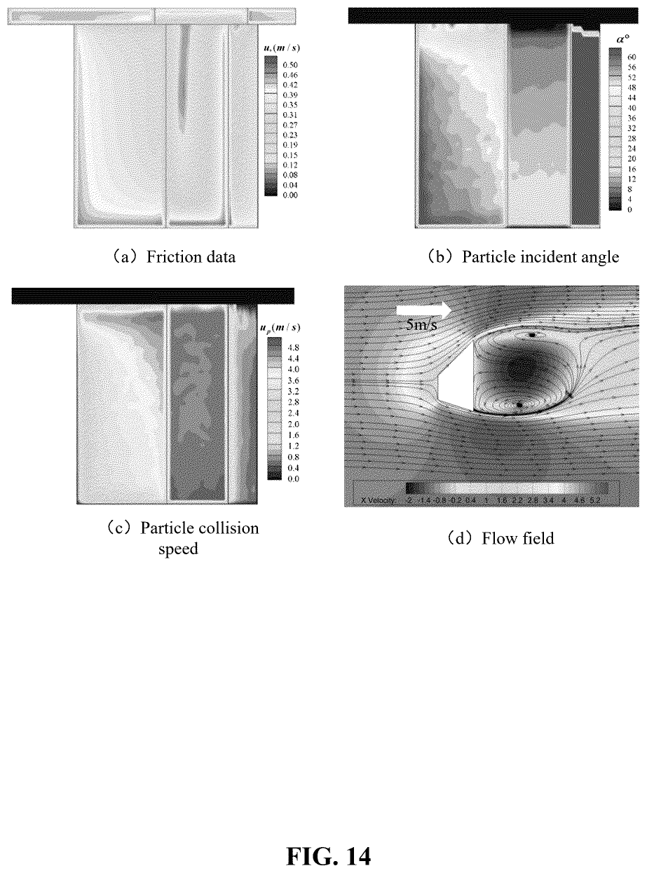

FIG. 14 is a schematic diagram illustrating cloud maps of a particle capture criterion and a flow field of a wedge 2 according to some embodiments of the present disclosure. FIG. 14(a) illustrates friction data, FIG. 14(b) illustrates a particle incident angle, FIG. 14(c) illustrates a particle collision velocity, and FIG. 14(d) illustrates a flow field.

In some embodiments, referring to FIG. 14, the particle incident angle and the friction velocity on the inclined surface increase along a diagonal direction toward the lower left region. The particle incident angle on the inclined surface increases significantly compared with that of the 36° right-angle wedge, mainly due to a change in the inclination angle of the inclined surface that causes flow separation characteristics of the flow field to vary substantially. The particle incident angle on the top surface is relatively small and exhibits a trend of increasing from the upper region toward the lower region, causing the particles to accumulate in the upper region. The region having the lower friction velocity appears in the upper region of the top surface, mainly due to flow separation around a bluff body, resulting in a decrease in wind velocity and forming a particle accumulation region. A concentrated region having a relatively low particle collision velocity appears in the upper middle region of the top surface, and the particles tend to accumulate in that region, which agrees with the snow accumulation region observed at the corresponding position in the experimental results.

The comparison of the snow depth cloud maps shows that the snow accretion distribution of the wedges having different angles and sizes is generally consistent with the simulation results. In actual engineering applications, more attention is focused on regions having a greater amount of snow accretion on the wall surface. To further quantitatively analyze a snow depth scale of the experimental results and the simulation results, the present disclosure analyzes local profile snow depth data in the snow accumulation region of the experimental results and the simulation results.

Experimental data of the snow depth on the top surface of the wedge model are listed in the following table:

| Measurement | Wedge 1 | | | Wedge 2 | | |
|---|---|---|---|---|---|---|
| Point | Experiment | Simulation | Average | Experiment | Simulation | Average |
| Number | (cm) | (cm) | error (%) | (cm) | (cm) | error (%) |
| 1 | 1.89 | 1.67 | 11.7 | 1.81 | 1.62 | 10.6 |
| 2 | 1.95 | 1.73 | 11.3 | 1.81 | 1.65 | 8.5 |
| 3 | 1.96 | 1.78 | 9.3 | 1.82 | 1.73 | 4.9 |
| 4 | 1.95 | 1.78 | 8.9 | 1.86 | 1.74 | 6.7 |
| 5 | 1.97 | 1.83 | 6.9 | 1.87 | 1.76 | 5.9 |
| 6 | 1.96 | 1.89 | 3.7 | 1.81 | 1.81 | 0 |
| 7 | 1.94 | 1.86 | 3.8 | 1.75 | 1.82 | −3.9 |
| 8 | 1.9 | 1.89 | 0.7 | 1.67 | 1.83 | −9.8 |
| 9 | 1.84 | 1.91 | −3.8 | 1.57 | 1.78 | −13.1 |
| 10 | 1.77 | 1.74 | 1.6 | 1.58 | 1.64 | −3.8 |

In some embodiments, the above table shows that the snow depth in the snow accumulation region on the top surface of the wedge model exhibits a trend of first increasing and then decreasing as the distance from the top of the wedge model decreases, which is generally consistent with the simulation results. At the same time, the experimental results and the simulation results show a very small difference (e.g., below 4%) at the extreme positions of snow depth, and peak snow depths in local regions are consistent.

Experimental data of the snow depth on the inclined surface of the wedge model are listed in the following table:

| Measurement | Wedge 1 | | | Wedge 2 | | |
|---|---|---|---|---|---|---|
| Point | Experiment | Simulation | Average | Experiment | Simulation | Average |
| Number | (cm) | (cm) | error (%) | (cm) | (cm) | error (%) |
| 1 | 1.53 | 1.44 | 6.4 | 1.77 | 1.55 | 12.6 |
| 2 | 1.56 | 1.47 | 6 | 1.75 | 1.58 | 10.1 |
| 3 | 1.61 | 1.54 | 4.4 | 1.75 | 1.58 | 9.6 |
| 4 | 1.65 | 1.58 | 3.9 | 1.74 | 1.63 | 6.6 |
| 5 | 1.68 | 1.62 | 3.5 | 1.75 | 1.74 | 0.8 |
| 6 | 1.71 | 1.65 | 3.2 | 1.76 | 1.75 | 0.6 |
| 7 | 1.72 | 1.67 | 2.9 | 1.76 | 1.71 | 3.1 |
| 8 | 1.76 | 1.74 | 0.9 | 1.75 | 1.79 | −2.2 |
| 9 | 1.8 | 1.79 | 0.6 | 1.76 | 1.82 | −3.2 |
| 10 | 1.84 | 1.8 | 2.2 | 1.79 | 1.73 | 3.2 |

In some embodiments, the above table shows that the snow depth in the snow accumulation region on the inclined surface of the wedge model exhibits a trend of first increasing as the distance from the top of the wedge model decreases. The relatively small snow depth appears at a boundary position, which is generally consistent with the simulation results. At the same time, the experimental results and the simulation results show a very small difference (e.g., below 4%) at the extreme positions of snow depth.

In some embodiments, to verify the feasibility of simulating snow removal of the obstacle removal snowplow using a discrete element method, the processor further performs numerical simulation analysis based on the snow removal test of a scaled obstacle removal snowplow model using real snow or substitute snow.

In some embodiments, a snow accumulation density of 200 kg/m³ is adopted in the quantitative comparison analysis of snow removal resistance of the snowplow. Based on a theory of porous-medium powder particle accumulation, a density conversion formula is expressed as:

$${ρ}_{s} = \frac{{ρ}_{s , 0} - ( 1 - {β}_{p} ) {ρ}_{a}}{{β}_{p}} ,$$

wherein ρₛ denotes a particle density, ρ_{s,0} denotes an apparent density, Bp denotes a particle volume fraction, and Pa denotes an air density having a value of 1.225 kg/m³.

Assuming that a natural snowfall accumulation mode is random accumulation, ρₐ of approximately 60% determines an absolute density of a single snow particle to be 333 kg/m³. In some embodiments, the snow particles used in the simulation using a discrete element method (DEM) have a density of 333 kg/m³. On the other hand, a friction coefficient and other collision parameters, such as the elastic modulus, the Poisson's ratio, and the restitution coefficient, are selected with reference to a material parameter table and a collision parameter table listed below.

Material Parameter Table

| Material | Poisson's ratio | Shear modulus |
|---|---|---|
| Snow particle | 0.25 | 2.000E+06 |
| Rigid body | 0.3 | 7.692E+10 |

Collision Parameter

| | Restitution | Static friction | Rolling friction |
|---|---|---|---|
| Contact type | coefficient | coefficient | coefficient |
| Snow-snow | 0.8 | 0.5 | 0.05 |
| Snow-rigid body | 0.6 | 0.3 | 0.05 |

A calculation expression of snow removal resistance (i.e., the snow removal resistance formula) is expressed as: Fₚ=ChwρV², wherein h denotes a snow removal depth, w denotes a snow removal width, ρ denotes a snow density, and V denotes a running velocity. C denotes the running resistance coefficient.

Through the DEM numerical simulation, the simulation results are in good agreement with the experimental results, and the comparison of corresponding data is listed in the following table:

| Operation | Simulation | Experimental | |
|---|---|---|---|
| condition | results | results | Average |
| Velocity (m/s) | Resistance (kN) | Resistance (kN) | error |
| 10 | 0.233 | 0.227 | −2.64% |
| 20 | 0.940 | 0.963 | −2.34% |
| 30 | 2.184 | 2.042 | 6.97% |
| 40 | 4.051 | 3.957 | 2.38% |

In some embodiments, compared with a prototype test, the average error of the snow removal resistance of the obstacle removal snowplow obtained in the simulation research is approximately 3.5%.

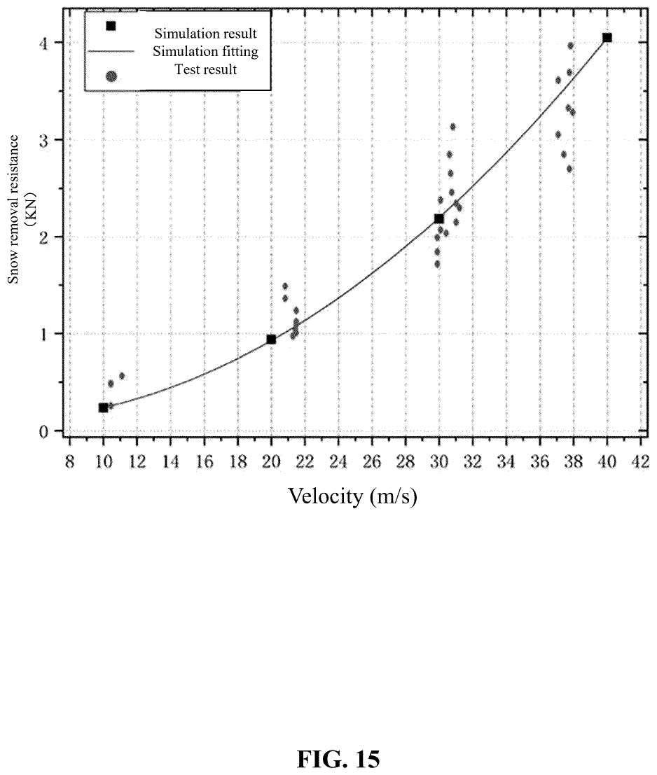

FIG. 15 is a schematic diagram illustrating regression fitting of DEM simulation data according to some embodiments of the present disclosure, where a horizontal axis represents the velocity and a vertical axis represents the snow removal resistance.

In some embodiments, by performing regression fitting analysis on the snow removal resistance of the obstacle removal snowplow under different running velocities, a quadratic relationship between the snow removal resistance and the velocity is determined, as illustrated in FIG. 15.

In some embodiments, a variation of a snow density has an influence on the snow removal resistance of the obstacle removal snowplow, and results obtained through numerical simulation are listed in the following table.

| Snow density | 100 | 200 | 300 | 400 | 500 | 600 | 750 | 900 |
|---|---|---|---|---|---|---|---|---|
| Snow | 0.609 | 1.251 | 1.968 | 2.581 | 3.297 | 3.99 | 5.011 | 5.963 |
| removal | | | | | | | | |
| resistance | | | | | | | | |

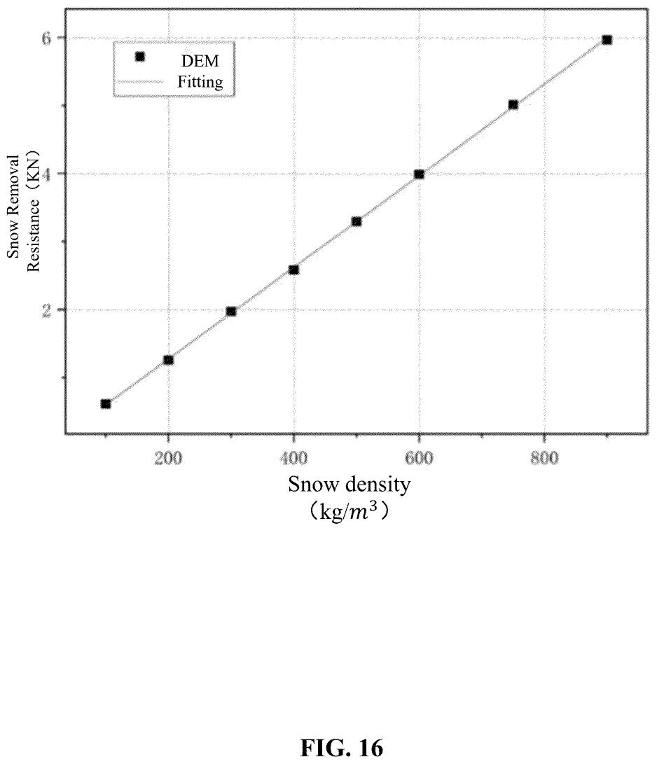

FIG. 16 is a schematic diagram illustrating a relationship between a snow density and snow removal resistance according to some embodiments of the present disclosure, where a horizontal axis represents the snow density and a vertical axis represents the snow removal resistance.

Through the analysis of the simulation results, differences in physical property data of the snow particles have an influence on the simulation results, and the relationship between the snow density and the snow removal resistance approximately satisfies a linear relationship, as illustrated in FIG. 16.

In some embodiments, to investigate the influence of the snowplow width on the snow removal resistance, the processor models the obstacle removal snowplow under a preset shape parameter combination (e.g., the opening angle of 90°, the inclination angle of 45°, the angle of attack of 55°, and the suppression angle of 44°). A total width of the obstacle removal snowplow is adjusted based on a width of 2 m to establish obstacle removal snowplows having different widths, and specific model parameters are listed as follows:

| Model width/ | Projection area of snow removal |
|---|---|
| reference width | of the snowplow model (m²) |
| 0.5 | 0.183 |
| 0.7 | 0.269 |
| 1 | 0.380 |
| 1.2 | 0.473 |

In some embodiments, since a snow removal width and a snow removal height of the obstacle removal snowplow mainly affect the snow removal area, the influence of variations in the width or the height on the snow removal resistance is considered as the influence of variations in the snow removal area caused by the variations in the width or the height on the snow removal resistance. The simulation is performed at a velocity of 30 m/s based on the model width/reference width, and results are listed as follows:

| Operation | Snow removal | Area | Resistance | Area |
|---|---|---|---|---|
| condition | resistance (kN) | (m²) | variation | variation |
| 0.5 | 34.5068 | 0.183 | 0.448 | 0.482 |
| 0.7 | 55.14995 | 0.269 | 0.716 | 0.709 |
| 1 | 77.02765 | 0.380 | 1.000 | 1.000 |
| 1.2 | 97.22775 | 0.473 | 1.262 | 1.246 |

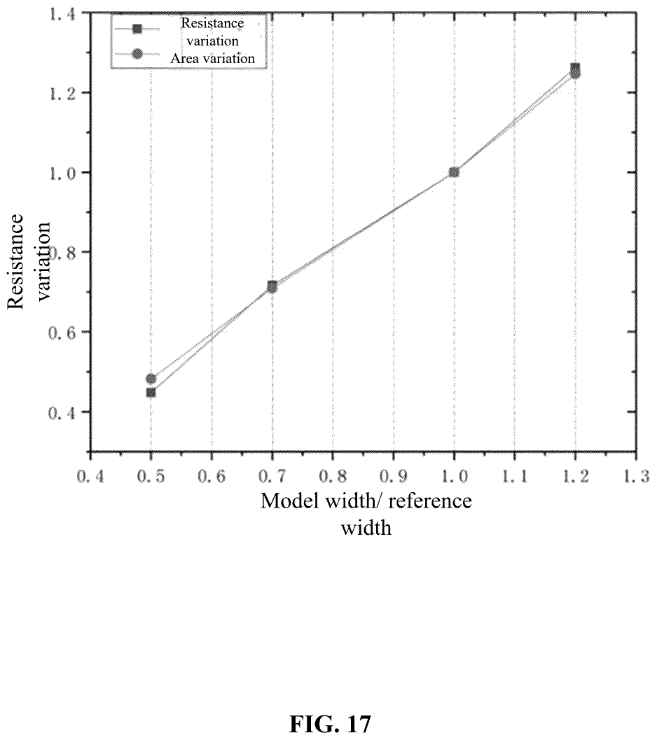

FIG. 17 is a schematic diagram illustrating a relationship between a model width/reference width and snow removal resistance according to some embodiments of the present disclosure, where a horizontal axis represents the model width/reference width, and a vertical axis represents the resistance variation.

Through the analysis of the simulation results, the relationship between the snow removal area and the snow removal resistance of the obstacle removal snowplow approximately satisfies a linear relationship, and the variation of the snow removal area is similar to the variation of the snow removal width. The relationship between the snow removal area and the snow removal resistance is simplified as a relationship between the snow removal width and the snow removal resistance, which approximately satisfies the linear relationship, as illustrated in FIG. 17.

In some embodiments, the influence of the snow removal depth on the snow removal resistance is investigated by changing a snow laying depth, and the obstacle removal snowplow model under the preset shape parameter combination is adopted. Similar to the snow removal width, the influence of the snow removal depth on the snow removal resistance is considered based on the variation of the snow removal area. The simulation is performed at a preset running velocity (e.g., 30 m/s) based on the model width/reference width, and results are listed as follows.

Snow removal depth

| Snow removal | Projection area of snow removal |
|---|---|
| depth (mm) | of the snowplow model (m²) |
| 100 | 0.194 |
| 150 | 0.288 |
| 200 | 0.380 |
| 250 | 0.472 |
| 300 | 0.585 |

Snow removal depth-snow removal resistance

| Snow removal | Snow removal | Area | Resistance | Area |
|---|---|---|---|---|
| depth (mm) | resistance (kN) | (m²) | variation | variation |
| 100 | 39.365 | 0.194 | 1.000 | 1.000 |
| 150 | 61.074 | 0.288 | 1.551 | 1.481 |
| 200 | 71.939 | 0.380 | 1.828 | 1.954 |
| 250 | 100.197 | 0.472 | 2.545 | 2.429 |
| 300 | 97.913 | 0.585 | 2.487 | 3.013 |

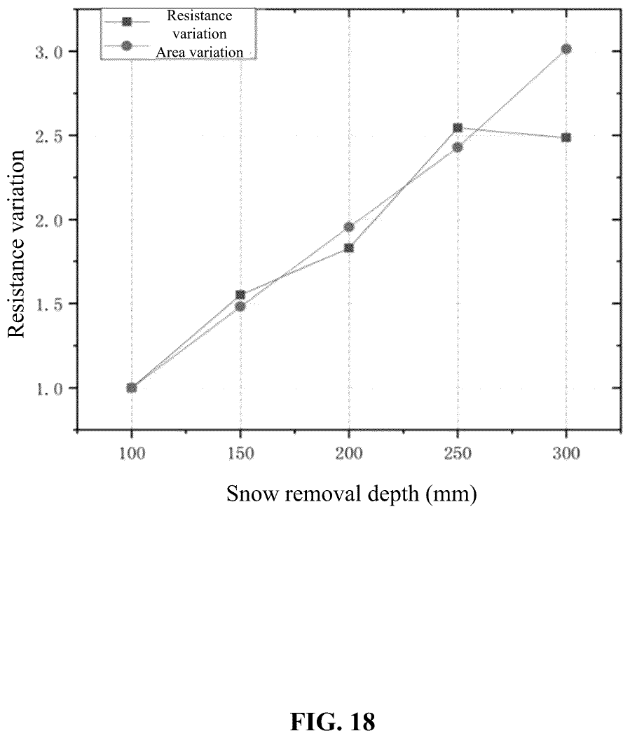

FIG. 18 is a schematic diagram illustrating a relationship between a snow removal depth and a resistance variation according to some embodiments of the present disclosure, where a horizontal axis represents the snow removal depth, and a vertical axis represents the resistance variation.

In some embodiments, through the analysis of the simulation results, the relationship between the snow removal depth and the snow removal resistance of the obstacle removal snowplow satisfies a linear relationship when the snow removal depth exceeds a height of a down pressure wing of the obstacle removal snowplow (i.e., a normal snow removal condition). However, in an extreme condition in which the snow removal depth is relatively large, due to the influence of the shape of the obstacle removal snowplow, the simulation result fails to satisfy the linear relationship, as illustrated in FIG. 18.

In summary, the numerical simulation results are in good agreement with experimental results. Meanwhile, based on simulation results regarding the influence of the snow density and the running velocity on the snow removal resistance of the obstacle removal snowplow, the snow removal resistance satisfies the formula: Fₚ=ChwρV².

Therefore, by conducting DEM discrete element simulation and experimental comparison analysis on snow removal of the scaled obstacle removal snowplow model, the feasibility of the research method proposed in the present research is verified from both quantitative and qualitative perspectives, and the conclusion are as follows.
(1) Differences in physical property parameters of the snow particles have a certain influence on the simulation results, and the snow density and the snow removal resistance of the obstacle removal snowplow satisfy an approximately linear relationship.
(2) Consistent with prototype test results, the relationship between the snow removal resistance of the obstacle removal snowplow and the running velocity approximately satisfies the quadratic relationship and satisfies the calculation formula of the snow removal resistance.
(3) The snow removal simulation of the obstacle removal snowplow exhibits high consistency with test results in a starting mode, a detachment mode, and the snow removal path during a snow removal process.
(4) The simulated snow removal resistance and the experimental snow removal resistance exhibit good agreement, with the average error of approximately 3.5%, demonstrating a high feasibility of using numerical simulation for research.

Therefore, the model of the obstacle removal snowplow is established. In addition to four angular shape parameters, such as the opening angle described above, the processor may select the shape of the obstacle removal snowplow from an overall form perspective before modeling. In some embodiments, the shape of the obstacle removal snowplow includes an open-type obstacle removal snowplow, a closed-type obstacle removal snowplow, etc.

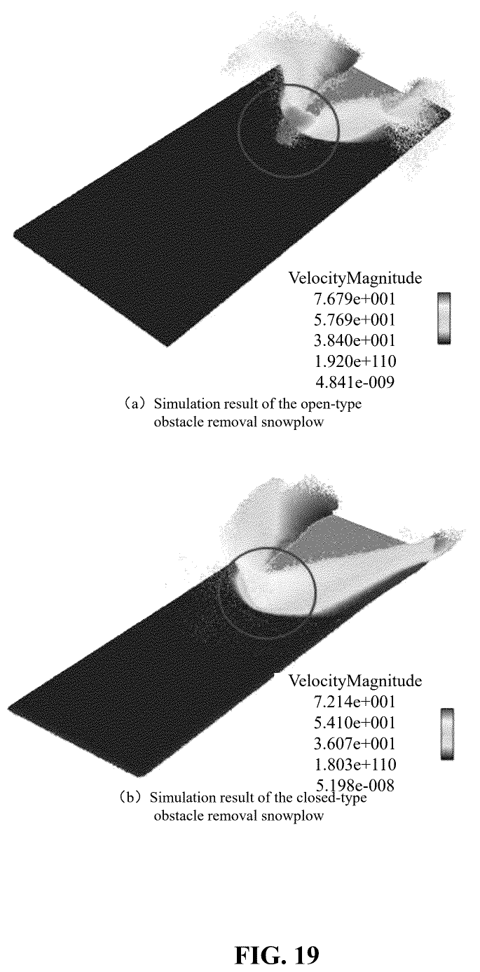

FIG. 19 is a schematic diagram illustrating simulation results of an open-type obstacle removal snowplow and a closed-type obstacle removal snowplow according to some embodiments of the present disclosure. FIG. 19(a) illustrates a simulation result of an open-type obstacle removal snowplow, and FIG. 19(b) illustrates a simulation result of a closed-type obstacle removal snowplow.

In some embodiments, the processor performs numerical simulation on two different types of obstacle removal snowplows using the numerical simulation method described above and qualitatively evaluates the shape of the obstacle removal snowplow. The simulation results are illustrated in FIG. 19.

Through comparison of the simulation results, the phenomenon of front-end snow overflow occurs during the snow removal process of the open-type obstacle removal snowplow. To further investigate the phenomenon, snow removal processes under different running velocities are calculated for a snow depth of 0.25 m. The running velocity is preset. For example, the running velocity is 72 km/h, 108 km/h, 140 km/h, 180 km/h, etc.

In some embodiments, as the running velocity increases, the phenomenon of front-end snow overflow becomes more significant. The phenomenon is undesirable for train operation from a force perspective, and since blowing snow is not cleared along a conventional snow removal path, the phenomenon adversely affects control of the snow removal path. An irregular snow removal path may even affect a driver's field of view. Accordingly, the closed-type obstacle removal snowplow is selected for optimization of the shape parameters.

In some embodiments, a three-dimensional model of the obstacle removal snowplow is constructed using the parametric modeling approach, and specific steps are as follows:

In S41, a horizontal plane is selected, and a specific position and a length of a line segment are determined based on a snowplow opening angle and a train width.

In S42, a vertical symmetry plane of the snowplow is selected, and a leading edge line segment of the snowplow and an angle of attack constraint line are determined based on a total height of the snowplow and a lower half height of the snowplow.

In S43, a lower half plane of the snowplow is generated based on the determined line segment.

In S44, a bottom line of the lower half plane of the snowplow is projected onto an upper edge plane of the snowplow by converting entity references to determine a reference plane where a rear spline curve is located.

In S45, the rear spline curve is determined based on a suppression angle and the train width, and boundary conditions include tangency to a plane determined by an angle of attack, a suppression angle constraint, and a suppression angle height constraint.

In S46, a front spline curve is determined, and boundary conditions include a foremost protrusion distance of the snowplow and tangency to an angle of attack plane and the line segment.

In S47, curved surfaces and planes are generated to complete modeling of half of the snowplow, and the entity is mirrored to complete modeling of the snowplow.

In some embodiments, the processor models the snowplow model in modeling software such as SolidWorks. The snowplow model is primarily controlled by the opening angle, the inclination angle, the angle of attack, and the suppression angle. After the shape parameters are determined, the processor determines an overall form of the snowplow based on geometric relationships. The upper half of the snowplow adopts a curved surface, and boundaries are constrained using spline curves. The snowplow model consisting of four curved surfaces is generated using a curved surface function. Since the modeling process of the snowplow is complicated and a large count of snowplow modeling operations are required during optimization, the processor uses a VBA function embedded in SolidWorks to simplify a process of double-spline-curve snowplow modeling in SolidWorks into a command stream.

In some embodiments, the processor studies the snow removal resistance of the obstacle removal snowplow using the numerical simulation method based on different combinations of shape parameters and heights of the obstacle removal snowplow.

In some embodiments, DEM numerical simulation results indicate that a variation of the opening angle has a significant influence on the snow removal resistance. As the opening angle increases, the snow removal resistance of the obstacle removal snowplow increases. When the opening angle is within a range of 60°-120°, the snow removal resistance increases by 2%, as shown in the following table:

| | | | Average | Normalized |
|---|---|---|---|---|
| | Snow removal | Normalized | pressure | average |
| Operation | resistance | snow removal | intensity | pressure |
| condition | (kN) | resistance | (Pa) | intensity |
| 60-45-0-55 | 151.579 | 0.58 | 27.9 | 0.54 |
| 90-45-0-55 | 216.745 | 0.83 | 44.0 | 0.85 |
| 120-45-0-55 | 260.159 | 1.00 | 52.0 | 1.00 |

“60-45-0-55” indicates that the opening angle is 60°, the inclination angle is 45°, the angle of attack is 0°, and the suppression angle is 55°. “90-45-0-55” indicates that the opening angle is 90°, the inclination angle is 45°, the angle of attack is 0°, and the suppression angle is 55°. “120-45-0-55” indicates that the opening angle is 120°, the inclination angle is 45°, the angle of attack is 0°, and the suppression angle is 55°.

Remaining inclination angle data, suppression angle data, and angle of attack data are shown in the following tables:

Inclination angle-snow removal resistance table

| Operation condition | Snow removal resistance (kN) |
|---|---|
| 90-30-0-55 | 221.045 |
| 90-45-0-55 | 216.745 |
| 90-75-0-55 | 218.240 |
| 90-90-0-55 | 220.762 |

The variation of the snow removal resistance is approximately 2% as the inclination angle increases, and a smaller snow removal resistance is observed when the inclination angle is approximately 45°.

Suppression angle-snow removal resistance table

| Operation condition | Snow removal resistance (kN) |
|---|---|
| 90-45-0-29 | 201.489 |
| 90-45-0-36 | 207.694 |
| 90-45-0-44 | 211.076 |
| 90-45-0-55 | 216.745 |

The variation of the snow removal resistance is approximately 4.7% as the suppression angle increases, and an overall upward trend is exhibited.

Angle of attack-snow removal resistance table

| Operation condition | Snow removal resistance (kN) |
|---|---|
| 90-45-0-55 | 216.745 |
| 90-45-5-55 | 221.473 |
| 90-45-10-55 | 232.188 |

The variation of the snow removal resistance is approximately 7.2% as the angle of attack increases, and an overall upward trend is exhibited.

Furthermore, height data of the obstacle removal snowplow is shown in the following table.

| Height of the | Snow removal |
|---|---|
| obstacle remover (mm) | resistance (kN) |
| 200 | 146.289 |
| 400 | 216.745 |
| 600 | 249.806 |

However, as the height of the obstacle remover (also referred to as the obstacle removal snowplow) increases, the snow removal resistance increases. Since the height of the obstacle removal snowplow directly affects the snow removal area, the simulation results indicate that the variation of the height of the obstacle removal snowplow has a relatively large influence on the snow removal resistance. However, different snow removal depths influence the snow removal areas corresponding to different heights of the obstacle removal snowplow, and thus the height of the obstacle removal snowplow is determined according to an actual snow removal depth.

Therefore, based on the above snow removal resistance formula, the processor introduces the shape parameters into the snow removal resistance formula according to the simulation results to simplify the calculation manner of the running resistance coefficient, facilitating estimation of the running resistance coefficient values of the snowplows having different shape parameters based on an existing running resistance coefficient.

The running resistance coefficient C is determined according to the following expression: C=C₀+C₁+C₂, wherein C₀ is determined based on linear interpolation by looking up a preset table:

| Opening angle (°) | 60 | 90 | 120 |
|---|---|---|---|
| C₀ | 3.95 × 10⁻⁴ | 5.64 × 10⁻⁴ | 6.77 × 10⁻⁴ |

C₁=0.028 (δ+2γ)×10⁻⁴, wherein δ is the suppression angle, and γ is the angle of attack.

In C₂: when θ<45°, C₂={5.64+0.008× (45−θ)}×10⁻⁴; when 45°≤0≤90°, C₂={5.64+0.0025×(θ−45)}×10⁻⁴, wherein θ is the inclination angle.

In some embodiments, a plurality of preset shape parameter combinations are provided, and the processor may determine a plurality of candidate shape parameter combinations based on an evaluation result of the snow removal performance of the obstacle removal snowplow under the plurality of preset shape parameter combinations. The processor may determine a target shape parameter combination based on the plurality of candidate shape parameter combinations and physical verification results of snowplow wedges corresponding to the plurality of candidate shape parameter combinations, and determine the snow removal resistance formula of the obstacle removal snowplow based on snow removal performance of the obstacle removal snowplow under the target shape parameter combination.

The candidate shape parameter combination refers to a shape parameter combination to be determined. In some embodiments, the shape parameter combination includes the opening angle, the inclination angle, the angle of attack, the suppression angle, etc. More descriptions regarding the opening angle, the inclination angle, the angle of attack, and the suppression angle may be found elsewhere in the present disclosure (e.g., FIG. 1 and descriptions thereof).

In some embodiments, the processor may determine preset shape parameter combinations whose snow removal performance satisfies a preset screening criterion as the candidate shape parameter combinations based on the evaluation result of the snow removal performance (e.g., the snow removal resistance) of the obstacle removal snowplow under the plurality of preset shape parameter combinations. The preset screening criterion may include that the snow removal resistance is less than a resistance threshold. The resistance threshold may be preset based on historical experience.

In some embodiments, the snowplow wedge is similar to the wedge 1 or the wedge 2. The processor may generate a corresponding wedge model based on each candidate shape parameter combination, and control a cutting device and a bending device based on the candidate shape parameter combination to manufacture the snowplow wedge.

In some embodiments, the processor may determine a two-dimensional cutting path of a leading edge plate and a side plate of the obstacle removal snowplow based on the opening angle and the inclination angle, and control the cutting device to perform cutting operation based on the two-dimensional cutting path. The processor may determine a bending line position and a bending angle of a guide inclined plate and a rear guide plate of the obstacle removal snowplow based on the angle of attack and the suppression angle, and control the bending device to perform bending operation based on the bending line position and the bending angle.

The two-dimensional cutting path may be a path for guiding the cutting device to perform the cutting operation.

In some embodiments, the processor may input the opening angle and the inclination angle as parameters into the obstacle removal snowplow model, and automatically generate a two-dimensional development drawing of the leading edge plate and the side plate using modeling software (e.g., SolidWorks), and extract and export contour boundaries of the development drawing as two-dimensional vector paths. The processor may convert the two-dimensional vector paths into G-code supported by the cutting device (e.g., a laser cutting machine, etc.), thereby forming the executable two-dimensional cutting path.

In some embodiments, the processor may upload the G-code to a CNC processor of the cutting device to control a laser head of the cutting device to move according to the two-dimensional cutting path and complete cutting, thereby forming the leading edge plate and the side plate.

The bending line position refers to a position line at which the bending device performs the bending operation on the guide inclined plate and the rear guide plate.

The bending angle refers to an included angle formed between plate surfaces after bending is performed at the bending line position.

In some embodiments, the processor may input the angle of attack and the suppression angle into the obstacle removal snowplow model, and automatically annotate the bending line position and the bending angle using modeling software to convert into CNC codes supported by the bending device (e.g., a CNC bending machine).

In some embodiments, the processor may upload the CNC codes to the CNC processor of the bending device to control the bending device to perform the bending operation at the bending line position according to the bending angle, thereby forming the guide inclined plate and the rear guide plate.

In some embodiments of the present disclosure, the shape parameter combinations are automatically mapped to laser cutting vectors and bending CNC codes, thereby forming an integrated digital thread from design to manufacturing, eliminating traditional lofting errors, improving forming accuracy, reducing trial-manufacturing cycles, and ensuring zero decaying of aerodynamic performance of the snowplow during manufacturing.

In some embodiments, the physical verification may include the snow accretion test described above. The physical verification results may include the snow removal resistance and the snow removal paths obtained through the snow accretion tests.

In some embodiments, the processor may record normal force data and shear force data generated during snow particle impact using force sensors disposed on the snowplow wedge in the snow accretion tests, and determine the snow removal resistance based on the normal force data and the shear force data. The processor may acquire images of flying snow trajectories using an image capture device, extract distributions of flying snow motion trajectories from the images of flying snow trajectories, and generate an envelope diagram of the trajectories to obtain the snow removal paths.

The target shape parameter combination refers to a determined shape parameter combination.

In some embodiments, the processor may screen the plurality of candidate shape parameter combinations based on the physical verification results of the snowplow wedges corresponding to the plurality of candidate shape parameter combinations, and select one candidate shape parameter combination having optimal snow removal performance as the target shape parameter combination.

In some embodiments, in response to the snow removal resistance in the snow removal performance being minimal and less than a resistance threshold, the snow removal path being continuous (a path having breakage or voids is regarded as discontinuous), and a deflection angle being stable, the processor determines the candidate shape parameter combination corresponding to the snow removal performance as the target shape parameter combination. The deflection angle refers to an included angle between the snow removal path and a running direction of the train. The deflection angle being stable refers to the deflection angle falling within a preset angular range during physical verification, and the preset angular range may be preset based on historical experience.

In some embodiments, based on the snow removal resistance formula described above, the processor simplifies the calculation manner of the running resistance coefficient by introducing the target shape parameter combination into the snow removal resistance formula based on the snow removal performance of the obstacle removal snowplow under the target shape parameter combination, and determines a new snow removal resistance formula.

In some embodiments of the present disclosure, by performing physical verification, a closed-loop decision process from parameter simulation screening to actual physical response confirmation is achieved, ensuring comprehensive performance of design parameters in both model simulation and physical environments, and improving the effect of subsequent whole vehicle simulation.

In S5, a train nose is added to the obstacle removal snowplow model to form a whole vehicle model, simulation is performed based on the whole vehicle model, the snow removal resistance formula is corrected, and a selection recommendation of the obstacle removal snowplow.

In some embodiments, to consider the influence of the train nose on snow removal of the obstacle removal snowplow in actual engineering, the processor may perform simulation based on the whole vehicle model with the train nose added, analyze the influence of the shape parameters on factors such as the snow removal resistance, and obtain a lateral force and a vertical force exerted on the whole vehicle during running.

In some embodiments, the processor may add the train nose to the obstacle removal snowplow model corresponding to the target shape parameter combination to form the whole vehicle model and perform simulation based on the whole vehicle model to correct the snow removal resistance formula and generate the selection recommendation of the obstacle removal snowplow.

In some embodiments, when simulation is performed based on the whole vehicle model, the processor may control a computational fluid dynamics solver and a discrete element method solver to perform bidirectional coupling operation at each preset operation duration.

The preset operation duration may be preset based on historical experience.

The computational fluid dynamics solver refers to a simulation module configured to simulate an air flow behavior in a train running environment. In some embodiments, the computational fluid dynamics solver may determine state variables such as velocity and pressure of air at various positions in space through numerical approaches to describe an air flow field state of the environment the snow particles are located.

The discrete element method solver refers to a simulation module configured to simulate motion states and interactions of a large count of snow particles. In some embodiments, the discrete element method solver may determine a force condition, a motion velocity, and a spatial position of each snow particle to achieve dynamic updating of a force response of the snow particle in the air flow field.

The bidirectional coupling operation refers to synchronous data interaction between different solvers.

In some embodiments, the bidirectional coupling operation includes: the computational fluid dynamics solver generating and transmitting the force exerted on the plurality of snow particles by air to the discrete element method solver, and the discrete element method solver generating and transmitting positions of the plurality of snow particles and reaction forces on the air to the computational fluid dynamics solver.

In some embodiments, at each preset operation duration, the computational fluid dynamics solver may determine an action force of air at the position of each snow particle based on current air velocity and pressure states, use a plurality of action forces of air as a sect of vector data to bind with identifiers of the snow particles, and transmit to the discrete element method solver.

In some embodiments, at each preset operation duration, after completing state updating of the plurality of snow particles, the discrete element method solver may extract the current position of each snow particle and the reaction force generated by the snow particle on surrounding air, and bind the reaction force data with the identifiers of the snow particles to transmit to the computational fluid dynamics solver.

In some embodiments of the present disclosure, by controlling bidirectional data transmission between the solvers, the physical coupling between the snow particles and air is achieved, realizing dynamic simulation of the particle-airflow interaction effect during snow removal, and improving physical accuracy of snow removal simulation.

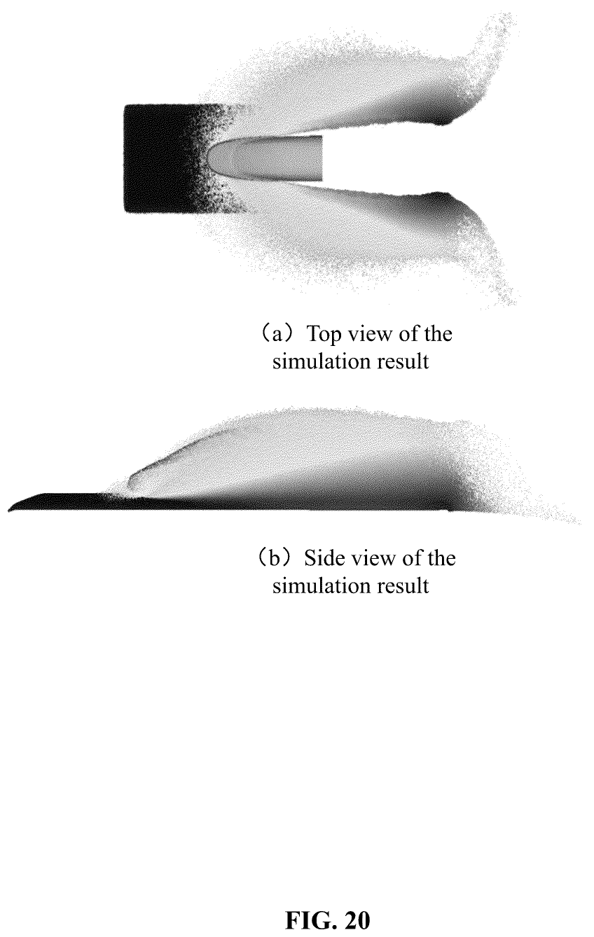

FIG. 20 is a schematic diagram illustrating simulation results of a whole vehicle model having an opening angle of 60°, an inclination angle of 45°, an angle of attack of 0°, and a suppression angle of 55° according to some embodiments of the present disclosure. FIG. 20(a) is a top view of the simulation result, and FIG. 20(b) is a side view of the simulation result.

In some embodiments, the processor takes the snowplow of 60-45-0-55 (the opening angle—the inclination angle—the angle of attack—the suppression angle) as an example to analyze forces exerted on the whole vehicle, with the snow depth of 400 mm and the running velocity of 40 m/s, and the simulation results may be found in FIG. 20.

In some embodiments, the summary of the snow removal resistance of the simulation results is as follows:
(1) In an X direction, the overall snow removal resistance of the whole vehicle model is increased by 26% compared with that of a single snowplow. The X direction may be a direction parallel to an extension direction of the train nose.
(2) In a Y direction, a maximum lateral force during snow removal is below 5 kN. The Y direction may be a direction parallel to the X direction at a horizontal height.
(3) In a Z direction, a vertical force is 269.8 kN and is oriented upward (whether a rate of wheel load reduction exceeds a preset value needs to be determined). The Z direction may be a direction perpendicular to a plane formed by the X direction and the Y direction.
(4) In the whole vehicle model, the snowplow has the snow removal resistance less than that of a single snowplow.

In some embodiments, the force in the Z direction needs to be further evaluated based on the rate of wheel load reduction, i.e., the rate of wheel load reduction does not exceed a preset value (e.g., the rate of wheel load reduction should not exceed 7%). The rate of wheel load reduction may characterize a degree to which a dynamic wheel load (i.e., a real-time wheel load during train motion) of a train wheel decreases relative to a static wheel load (i.e., the wheel load when the train is stationary).

In some embodiments, the rate of wheel load reduction may be a ratio of a difference between the static wheel load and the dynamic wheel load to the static wheel load.

Meanwhile, it can be found that since the train nose shares the snow removal resistance, the snow removal resistance of the whole vehicle is less than that of a single snowplow in simulation, and specific simulation results are as follows:

| | Single | Whole | Whole | |
|---|---|---|---|---|
| | snowplow | vehicle- | vehicle-train | Whole |
| Direction | (kN) | snowplow | nose | vehicle |
| X | 151.929 | 130.680 | 60.898 | 191.578 |
| Y(MAX) | 2.454 | 0.993 | 0.684 | 1.677 |
| Z | −43.7/14.6 | | 269.8 | |

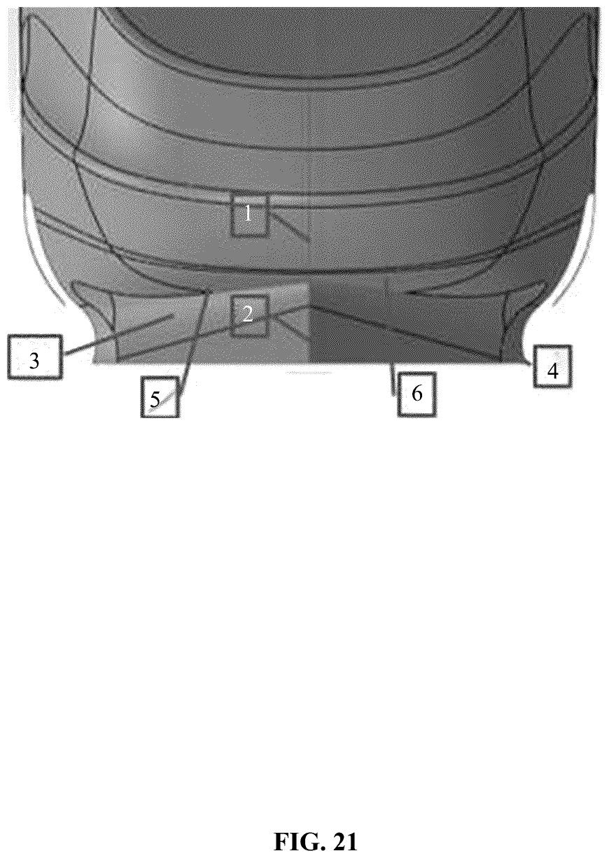

FIG. 21 is a schematic diagram illustrating locations of pressure measurement points according to some embodiments of the present disclosure.

In some embodiments, the processor may extract a wall surface pressure intensity value at a corresponding pressure measurement point, and the wall surface pressure intensity value and the locations of the pressure measurement points may be found in FIG. 21 and the table below:

| No. | 1 | 2 | 3 | 4 | 5 | 6 |
|---|---|---|---|---|---|---|
| Pressure | 0 (not | 6.282 × 10⁵ | 9.451 × 10⁵ | 9.224 × 10⁵ | 9.287 × 10⁴ | 9.632 × 10⁴ |
| intensity | involved) | | | | | |
| (Pa) | | | | | | |

In some embodiments, by analyzing the simulation results, the processor may find that a pressure measurement point 1 does not participate in snow removal under this operation condition and thus has no pressure intensity value, and for other pressure measurement point regions, a middle region has a relatively large pressure intensity value. In addition, the overall pressure intensity values are less than 1 MPa. Compared with an experimental result of 1.18 MPa (snowpack bulk density of 200 kg/m³, running velocity of 40 m/s, snow depth of 40 mm, and model scale ratio of 1:5), the two results are consistent in magnitude and reliable. Meanwhile, the snowplow with the train nose added has better snow removal performance than the snowplow used in the experiment.

In some embodiments, due to mutual influence between the train nose and the snowplow model, the snowplow of the whole vehicle model shows differences in the snow removal process compared to the case of the single snowplow due to the influence of the shape parameters. Accordingly, the processor may perform numerical simulation analysis on the opening angle with relatively significant influence and the angle of attack with relatively large influence on a windward snow area, and adjust the snow removal resistance formula for the single snowplow.

In some embodiments, considering the influence of the opening angle, the processor may perform the numerical simulation including the train nose model for the opening angle of the single snowplow:

| Opening | Train nose | Snowplow | Overall |
|---|---|---|---|
| angle (°) | resistance (kN) | resistance (kN) | resistance (kN) |
| 60 | 51.502 | 147.142 | 198.644 |
| 90 | 63.772 | 174.027 | 237.799 |
| 120 | 57.447 | 187.481 | 244.928 |

Through the simulation results, the processor find that the train nose model has a relatively large influence on motion of the snow particles during snow removal. When the opening angle is 60° or 90°, the presence of the train nose is unfavorable for reducing the snow removal resistance, while the opening angle is 120°, the presence of the train nose plays a favorable role in reducing the snow removal resistance. Meanwhile, the presence of the train nose further restricts motion of the snow particles. It can be observed that in the whole vehicle model, the influence of the opening angle on the snow removal resistance is smaller compared to the case of the single snowplow, but a relatively significant influence still exists.

In some embodiments, the processor may adjust a value of a parameter C₀, which considers the influence of the opening angle in the running resistance coefficient provided above based on the simulation results. Because in the whole vehicle model, the resistance variation of parts other than the obstacle removal snowplow of the train nose is relatively small as the opening angle changes, the processor may simplify the resistance of those parts and the resistance of the snowplow into one term, i.e., the snow removal resistance of the whole vehicle during running is considered. Meanwhile, because the snow laying depth is the same as the snowplow height, the influence of the train nose model on the snow removal area is very small when the opening angle changes. To simplify a calculation model, the processor may ignore the influence of remaining parts of the train nose on the snow removal area. In summary, for the whole vehicle model, C₀ is adjusted based on the snow removal resistance of the whole vehicle and valued according to the following table:

| Opening angle (°) | 60 | 90 | 120 |
|---|---|---|---|
| C₀ | 3.10 × 10⁻⁴ | 3.72 × 10⁻⁴ | 3.83 × 10⁻⁴ |

Since the variation of the angle of attack causes a certain influence on the windward snow area, the processor may also verify the variation of the snow removal resistance of the whole vehicle model in case of the variation of the angle of attack. Specific simulation results may be found in the table below.

| Angle of | Train nose | Snowplow | Overall |
|---|---|---|---|
| attack (°) | resistance (kN) | resistance (kN) | resistance (kN) |
| 0 | 63.772 | 174.027 | 237.799 |
| 5 | 71.085 | 166.228 | 237.313 |
| 10 | 81.223 | 150.014 | 231.237 |

The simulation results show that the influence of the variation of the angle of attack on the snow removal resistance of the whole vehicle is smaller compared to the case of the single snowplow, because the train nose model compensates for the variation of the snow removal area caused by the variation of the angle of attack of the single snowplow. However, for the snow removal path, the variation of the angle of attack causes a certain influence on the distribution of the snow removal path during running.

Therefore, the selection recommendation of the obstacle removal snowplow in the present disclosure mainly considers the snow removal resistance, and the snow removal path and model factors are supplementary considerations. However, since the influence of the suppression angle on the snow removal resistance is not significant and the snow depth considered above is close to an extreme snowfall condition, the function of the suppression angle cannot be effectively realized, and the influence of the suppression angle on the snow removal path under this operation condition is not clear. Considering use of the snowplow under a normal snow depth, the influence of the suppression angle on the snow removal resistance and the snow removal path under a relatively small snow depth is considered.

In some embodiments, under the condition of 400 mm snow depth, due to a large snow removal amount and a high snow removal velocity, the influence of the suppression angle on the snow removal path is not significant. The processor may simulate the influence of the suppression angle on the snow removal resistance and the snow removal path under the relatively small snow depth. The snow depth of 150 mm and the running velocity of 30 m/s are used for simulation, and other parameters remain unchanged. Results are shown in the table below:

| Suppression angle (°) | Snow removal resistance (kN) |
|---|---|
| 29 | 55.656 |
| 36 | 56.761 |
| 44 | 58.543 |
| 55 | 59.613 |

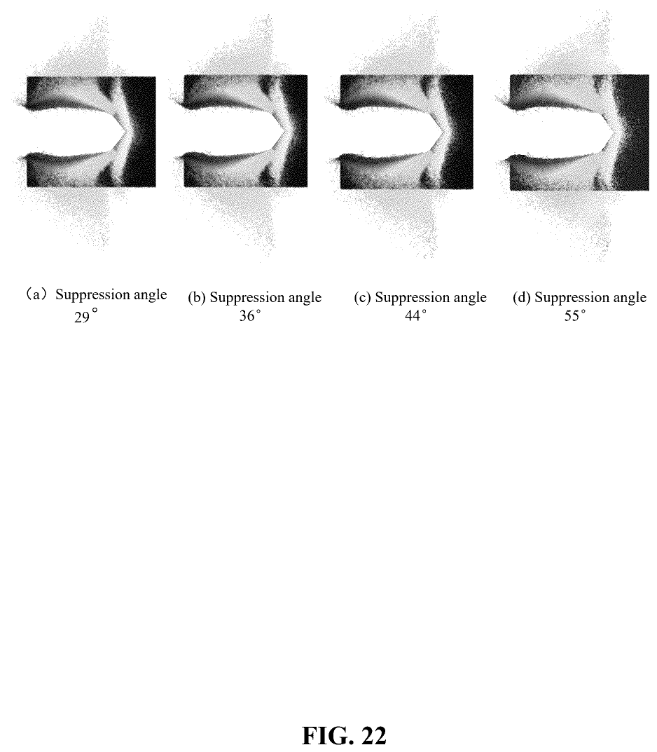

FIG. 22 is a schematic diagram illustrating comparison of snow removal widths under different suppression angles according to some embodiments of the present disclosure. FIG. 22(a) is a schematic diagram illustrating a snow removal width under a suppression angle of 29°, FIG. 22(b) is a schematic diagram illustrating a snow removal width under a suppression angle of 36°, FIG. 22(c) is a schematic diagram illustrating a snow removal width under a suppression angle of 44°, and FIG. 22(d) is a schematic diagram illustrating a snow removal width under a suppression angle of 55°.

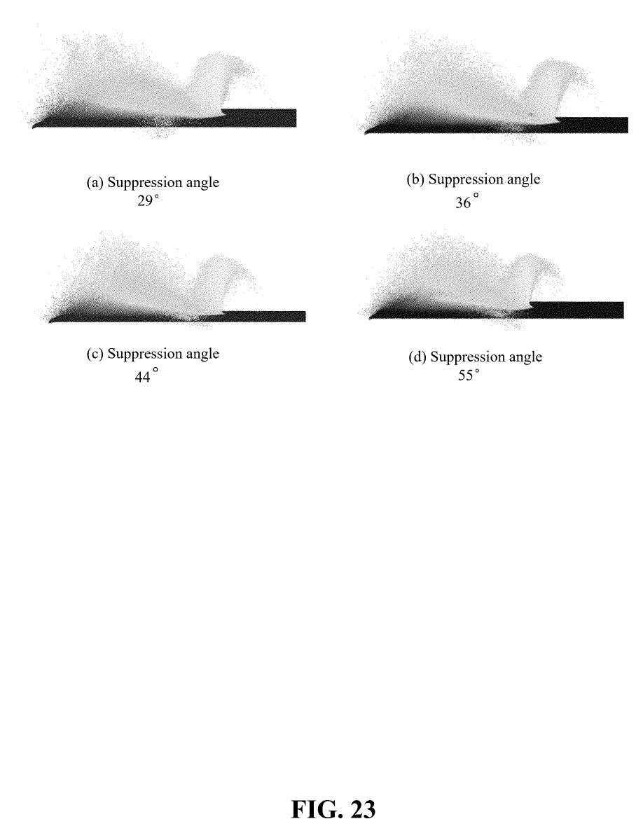

FIG. 23 is a schematic diagram illustrating comparison of snow removal heights under different suppression angles according to some embodiments of the present disclosure. FIG. 23(a) is a schematic diagram illustrating a snow removal height under a suppression angle of 29°, FIG. 23(b) is a schematic diagram illustrating a snow removal height under a suppression angle of 36°, FIG. 23(c) is a schematic diagram illustrating a snow removal height under a suppression angle of 44°, and FIG. 23(d) is a schematic diagram illustrating a snow removal height under a suppression angle of 55°.

In some embodiments, referring to FIG. 22 and FIG. 23, the snow removal width increases as the suppression angle increases, and the motion velocity of the snow particles increases during snow removal. By comparing snow removal heights under different suppression angles, it can be seen that in the snow removal path behind the snowplow, the snow particles tend to be distributed at a lower height and the snow particles distributed are more concentrated and orderly when the suppression angle is smaller. Accordingly, a smaller suppression angle is evidently more favorable for controlling the motion path of the snow particles distributed during snow removal in running.

Therefore, the processor provides the following selection recommendation of the obstacle removal snowplow: (1) the opening angle has the most significant influence on the snow removal resistance, from the perspective of the snow removal resistance, the opening angle of 60° is recommended. (2) When the inclination angle is approximately 45°, the snow removal resistance in the X direction is the smallest, and the inclination angle of 45° is recommended. (3) For the angle of attack, the snow removal path needs to be comprehensively considered. The results show that the influence of the variation of the angle of attack on the snow removal resistance in the Z direction and the snow removal width is small, but the influence on the snow removal height exists, reflected in fewer snow particles at a higher position when the angle of attack increases. At the same time, comprehensively considering that an increase in the angle of attack leads to an increase in the snow removal resistance, the angle of attack of 5° is recommended. (4) Under the snow depth of 400 mm, the influence of the suppression angle on the snow removal path is not significant. Under a relatively small snow depth, when the suppression angle is 29°, the snow removal height is better controlled and the snow removal resistance is relatively small, and the suppression angle of 29° is recommended. In conclusion, the snowplow with the shape parameters of 60° (the opening angle)-45° (the inclination angle)-5° (the angle of attack)-29° (the suppression angle) is recommended.

In S6: simulation is performed under a preset snow depth and running velocity to obtain train forces and snow removal paths under different snow depths and running velocities, and a maximum velocity capable of satisfying an actual operation requirement under different snow depths is generated based on a preset constraint condition.

The snow depth has a significant influence on a force state of the train body during running. Considering that in actual engineering, the train needs to operate normally under a small snow depth, and operates at a velocity limit under a large snow depth. Therefore, the present disclosure studies different snow depths and running velocities, obtains, through the numerical simulation, the train forces and the snow removal paths under different snow depths and running velocities, and provides the maximum velocity capable of satisfying the actual operation requirement under different snow depths based on the constraint condition, so as to provide a reference for train operation in the environment of snow accumulation.

In some embodiments, the processor may perform simulation at the preset snow depth and running velocity based on the constraint condition that the rate of wheel load reduction does not exceed a preset value and the driver's field of view is clear, and generate the maximum velocity (also referred to as a maximum running velocity) capable of satisfying the actual operation requirement under different snow depths. Since the snow removal snowplow is provided at a front end of a leading vehicle, the influence of the snow removal snowplow on the wheel load reduction exists only for the leading vehicle, and only an amount of wheel load reduction (also referred to as the rate of wheel load reduction) of the leading vehicle is considered herein. Specifically, the following formula needs to be satisfied:

$$\frac{Δ p}{p} \leq 7 \% ,$$

wherein Δp is the amount of wheel load reduction caused by snow removal, and p is an average net wheel load.

According to design conditions, the leading vehicle weighs 64 t, i.e., p=640 kN. According to the above formula, the amount of wheel load reduction caused during the snow removal process satisfies Δp≤44.8 kN.

The driver's field of view being clear refers to that the snow removal height is not higher than the driver's field of view. The driver's field of view may be represented by a preset height line.

In some embodiments, the constraint condition may further include that a structural stress at a connection between the obstacle removal snowplow and the train nose satisfies a first preset condition, and a side cast angle of snow at an end of the obstacle removal snowplow satisfies a second preset condition.

The structural stress at the connection between the obstacle removal snowplow and the train nose refers to a local stress generated when a force is transmitted between the snowplow structure and the train nose through connecting components (e.g., welded parts or bolt assemblies) during running.

The first preset condition may be that the structural stress at the connection between the obstacle removal snowplow and the train nose is less than a fatigue limit.

The fatigue limit refers to a maximum stress amplitude at which a material used in the connecting components does not undergo fatigue failure under cyclic loading. In some embodiments, the fatigue limit may be determined by material properties of the connecting components and prestored in the processor.

The side cast angle of snow at the end of the obstacle removal snowplow refers to an included angle between a motion direction in which the snow particles are cast toward a side of the train in an end region of the snowplow and a traveling direction of the train. In some embodiments, the side cast angle of snow at the end of the obstacle removal snowplow may reflect a lateral diffusion range of the snow particles, and an excessively large side cast angle of snow may cause interference with adjacent trains, track signal devices, or roadside facilities.

The second preset condition may be that the side cast angle of snow at the end of the obstacle removal snowplow is less than a side cast angle threshold. In some embodiments, the side cast angle threshold may be preset based on a train spacing or a safety distance between tracks, such as 30°, etc.

In some embodiments of the present disclosure, by introducing dual constraints of the structural stress and the side cast angle of snow, structural strength safety and adjacent line compatibility of the snowplow in actual operation are ensured, fatigue failure risks are reduced, the interference caused by flying snow to the adjacent trains or facilities is prevented, and the safety and stability of the train in a snowfall environment are improved.

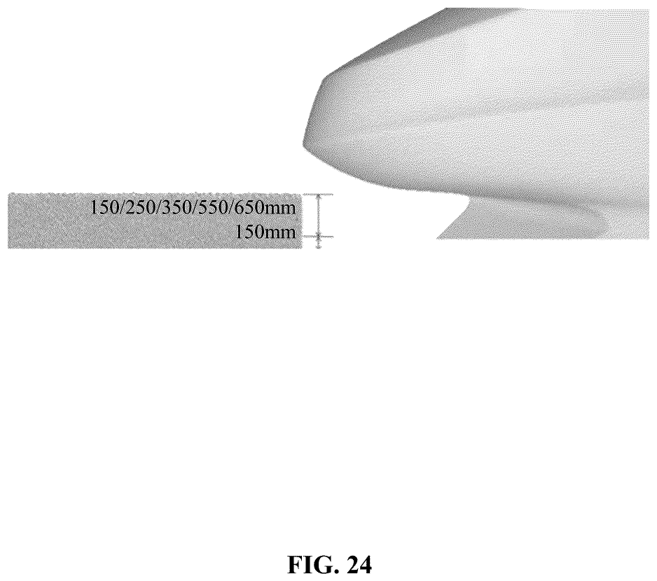

FIG. 24 is a schematic diagram illustrating a numerical simulation computational domain according to some embodiments of the present disclosure.

Therefore, the present disclosure performs numerical simulation at the snow accumulation depths of 150 mm, 300 mm, 600 mm, and 800 mm. The snow removal depth is obtained based on a lower edge of the snowplow being 150 mm above a rail surface, as shown in FIG. 24. Considering the influence of snow laying from the rail surface to the lower edge of the snowplow on snow removal, the snow laying depth in the simulation is taken as the snow accumulation depth, and the snow removal height is ensured by adjusting the model height, as shown in FIG. 24.

According to the above research, as the snow depth increases, the amount of wheel load reduction caused by snow removal changes significantly, resulting in a large variation in velocity limit. To improve computational efficiency, an initial value of the running velocity under a relatively large snow depth is selected with reference to the simulation results under a relatively small snow depth, and then the running velocity is decreased with a gradient of 20 km/h until the constraint condition is satisfied. The specific operation conditions are summarized in the following table:

| Snow | Snow | |
|---|---|---|
| accumulation | removal | Running |
| depth (mm) | depth (mm) | velocity (km/h) |
| 300 | 150 | 250/230/210/190/170 |
| 400 | 250 | 190/170/150/130/110/90/70 |
| 500 | 350 | 90/70/50 |
| 600 | 450 | 70/50 |
| 700 | 550 | 70/50/30 |
| 800 | 650 | 50/30 |

In some embodiments, the amount of wheel load reduction caused by snow removal under each operation condition may be obtained through numerical simulation. Combined with the snow removal path, the maximum running velocity capable of satisfying the actual operation requirement under different snow depths may be determined. According to a task requirement, the pressure intensity value at each pressure measurement point under the maximum running velocity and the snow removal resistance in the traveling direction under the corresponding condition are provided for reference.

According to the simulation results, under the snow accumulation depth of 300 mm, i.e., the snow removal depth of 150 mm, the train may run at a velocity of 170 km/h while ensuring that the amount of wheel load reduction and the snow removal path satisfy corresponding requirements. The specific results are as follows:

| | | | Snow removal resistance in | | | | | | |
|---|---|---|---|---|---|---|---|---|---|
| | | | traveling direction (kN) | | | Vertical snow removal resistance (kN) | | | |
| | | Snow | | Other | | | Other | | |
| | Snow | removal | Snow | parts of | | Snow | parts of | Bottom | |
| Running | accumulation | depth | removal | train | | removal | train | sealing | |
| velocity | depth (mm) | (mm) | snowplow | nose | Total | snowplow | nose | plate | Total |
| 250 | 300 | 150 | 142.285 | 5.967 | 148.252 | 20.018 | 6.758 | 41.957 | 68.732 |
| 230 | 300 | 150 | 115.184 | 5.507 | 132.384 | 17.200 | 6.700 | 36.146 | 60.046 |
| 210 | 300 | 150 | 101.401 | 5.093 | 106.494 | 13.892 | 7.174 | 31.015 | 52.081 |
| 190 | 300 | 150 | 87.753 | 4.379 | 92.132 | 12.303 | 6.048 | 25.120 | 44.370 |
| 170 | 300 | 150 | 70.871 | 3.584 | 74.455 | 13.496 | 5.468 | 18.177 | 37.142 |

The pressure intensity value at each measurement point of the train nose during running at the maximum running velocity under the snow accumulation depth is as follows:

| No. | 1 | 2 | 3 | 4 | 5 | 6 |
|---|---|---|---|---|---|---|
| Pressure | 0 (not | 4.588 × 10⁵ | 2.094 × 10⁵ | 2.238 × 10⁵ | 0 (not | 0 (not |
| intensity | involved) | | | | involved) | involved) |
| (Pa) | | | | | | |

In summary, under the snow accumulation depth of 300 mm, the running velocity between 170 km/h and 190 km/h satisfies the requirements for the amount of wheel load reduction and the driver's field of view. Furthermore, according to the results of a vertical snow removal force (also referred to as a vertical force), when running at the maximum velocity under this condition, the vertical snow removal force exceeds a limit value by only 23.9 kN, which is 1.53 times the limit value and is significantly different from the vertical snow removal force, indicating that the snow removal state remains reasonable under the operation condition.

According to the simulation results, under the snow accumulation depth of 600 mm, i.e., the snow removal depth of 450 mm, the train may run at a velocity of 50 km/h while ensuring that the amount of wheel load reduction and the snow removal path satisfy corresponding requirements. The specific results are as follows:

| | | | Snow removal resistance in | | | | | | |
|---|---|---|---|---|---|---|---|---|---|
| | | | traveling direction (kN) | | | Vertical snow removal resistance (kN) | | | |
| | Snow | Snow | | Other | | | Other | | |
| | accumulation | removal | Snow | parts of | | Snow | parts of | Bottom | |
| Running | depth | depth | removal | train | | removal | train | sealing | |
| velocity | (mm) | (mm) | snowplow | nose | Total | snowplow | nose | plate | Total |
| 70 | 600 | 450 | 43.185 | 27.009 | 70.194 | −3.683 | 89.045 | 2.627 | 87.988 |
| 50 | 600 | 450 | 17.962 | 14.502 | 32.464 | −2.101 | 43.076 | 0.448 | 41.423 |

The pressure intensity value at each measurement point of the train nose during running at the maximum running velocity under the snow accumulation depth is as follows:

| Index | 1 | 2 | 3 | 4 | 5 | 6 |
|---|---|---|---|---|---|---|
| Pressure | 0 (not | 1.509 × 10⁵ | 5.889 × 10⁴ | 4.154 × 10⁴ | 3.184 × 10⁴ | 3.297 × 10⁴ |
| intensity | involved) | | | | | |
| (Pa) | | | | | | |

Under the operation condition, the snow removal depth has exceeded a maximum height of the snowplow, and other parts of the train body gradually begin to directly participate in the snow removal process. The pressure intensity results also show that under the operation condition, the train body begins to participate in the snow removal process at a measurement point 5 and a measurement point 6.

According to the simulation results, under the snow accumulation depth of 800 mm, i.e., the snow removal depth of 650 mm, the train may run at a velocity of 30 km/h while ensuring that the amount of wheel load reduction and the snow removal path satisfy corresponding requirements. The specific results are as follows:

| | | | Snow removal resistance in | | | | | | |
|---|---|---|---|---|---|---|---|---|---|
| | | | traveling direction (kN) | | | Vertical snow removal resistance (kN) | | | |
| | Snow | Snow | | Other | | | Other | | |
| | accumulation | removal | Snow | parts of | | Snow | parts of | Bottom | |
| Running | depth | depth | removal | train | | removal | train | sealing | |
| velocity | (mm) | (mm) | snowplow | nose | Total | snowplow | nose | plate | Total |
| 50 | 800 | 650 | 19.469 | 24.915 | 44.384 | −2.168 | 59.448 | 0.313 | 57.593 |
| 30 | 800 | 650 | 9.186 | 10.305 | 19.491 | −0.998 | 25.186 | 0.064 | 24.252 |

The pressure intensity value at each measurement point of the train nose during running at the maximum running velocity under the snow accumulation depth is as follows:

| Index | 1 | 2 | 3 | 4 | 5 | 6 |
|---|---|---|---|---|---|---|
| Pressure | 2.185 × 10³ | 1.015 × 10⁵ | 4.058 × 10⁴ | 3.929 × 10⁴ | 1.879 × 10⁴ | 1.586 × 10⁵ |
| intensity | | | | | | |
| (Pa) | | | | | | |

This operation condition represents a maximum snow depth in the present disclosure. Under the operation condition, the pressure intensity results indicate that structures of all measurement points participate in the snow removal process, and the velocity limit is further reduced.

By observing the pressure intensity distribution on surfaces of the train nose and the snowplow during the snow removal process, a relatively large pressure intensity is generated on a lower surface of a protruding portion of the train nose after the snow depth exceeds a normal snow removal height of the snowplow. Under an extreme snow accumulation condition, reducing the length of the protruding portion of the train nose may be considered. By observing the snow removal path of the single snowplow and the snow removal path of the whole vehicle model, the protruding portion of the train nose plays a favorable role in controlling the front-end snow removal height during running. Accordingly, in case of shortening the length of the protruding portion of the train nose to reduce the amount of wheel load reduction, the requirement for the driver's field of view during running is ensured, i.e., the front-end snow removal height is not higher than the driver's field of view.

According to the results of velocity limit and variations of resistance and lift provided above, when the snow accumulation depth increases from 150 mm to 250 mm, the snow depth reaches a normal operation height of the snowplow. During the snow removal process, particle extrusion causes the snowplow to enter a relatively unreasonable snow removal mode (surfaces of structures on the train nose other than the snowplow all participate in the snow removal process). Meanwhile, the variation of the velocity limit is the most significant in this stage, and the velocity limit decreases from 170 km/h-190 km/h at the snow accumulation depth of 150 mm to 70 km/h-90 km/h.

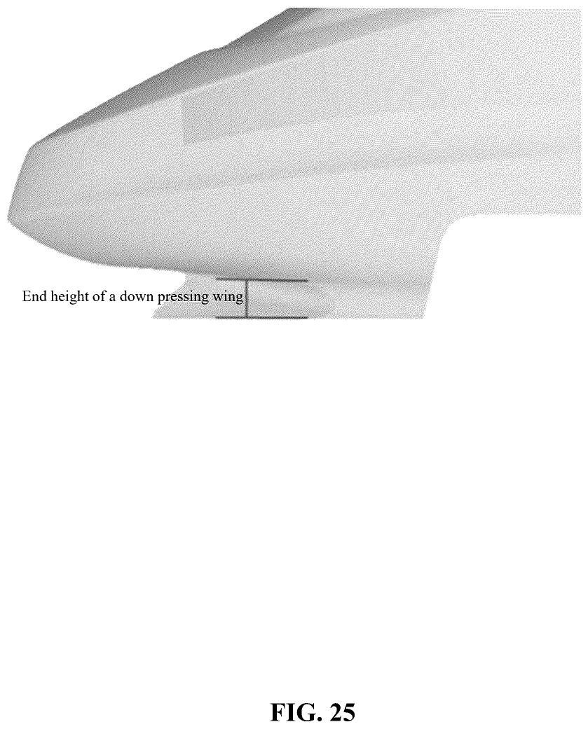

FIG. 25 is a schematic diagram illustrating an end height of a down pressing wing according to some embodiments of the present disclosure.

When the train requires to operate in an environment with a larger snow accumulation depth, the normal operation height of the snowplow, i.e., the end height of the down pressing wing needs to be increased during design, as shown in FIG. 25.

Accordingly, the amount of wheel load reduction being less than 7% and the flying snow path that ensures the driver's field of view are taken as evaluation criteria in the present disclosure. The maximum running velocity of the train under different snow accumulation depths is investigated through the numerical simulation method, and the results are summarized in the following table:

| Snow | | |
|---|---|---|
| accumulation | Snow removal | Velocity |
| depth (mm) | depth (mm) | limit (km/h) |
| 300 | 150 | 170 |
| 400 | 250 | 70 |
| 500 | 350 | 50 |
| 600 | 450 | 50 |
| 700 | 550 | 30 |
| 800 | 650 | 30 |

Based on the above results, the following conclusions can be drawn: (1) to reduce the amount of wheel load reduction during the snow removal process, the distance from the snowplow to the foremost end of the train nose can be shortened under the condition that the driver's field of view is ensured. (2) Under the operation environment with a relatively large snow accumulation depth, the height of the snowplow is appropriately increased to ensure the rationality of the snow removal process.

Although embodiments of the present disclosure have been shown and described above, it is understood that the embodiments are exemplary and shall not be construed as a limitation to the present disclosure. Various changes, modifications, substitutions, and alterations to the above embodiments may be made by those having ordinary skills in the art within the scope of the present disclosure.

The present disclosure further provides a simulation and optimization design apparatus for an EMU obstacle removal snowplow based on multi-physical field coupling, wherein the apparatus includes a processor. The processor is configured to execute the method described in the foregoing embodiments.

In addition, certain features, structures, or characteristics of one or more embodiments of the present disclosure may be combined in an appropriate manner.

In some embodiments, numbers describing components and attribute quantities are used. It should be understood that such numbers used to describe the embodiments, in some examples, are modified by the modifiers “approximately,” “approximate,” or “substantially.” Unless otherwise stated, “approximately,” “approximate,” or “substantially” indicates that the stated number allows a variation of +20%. Accordingly, in some embodiments, numerical parameters used in the specification and claims are approximate values, which may vary according to the characteristics required by individual embodiments. In some embodiments, numerical parameters should consider specified significant digits and adopt a general method of digit retention. Although numerical ranges and parameters for confirming their breadth of scope in some embodiments of the present disclosure are approximate values, in specific embodiments, the setting of such numerical values is as precise as possible within a feasible range.

If the description, definition, and/or use of terms in the referenced materials are inconsistent with or conflict with those described in the present disclosure, the description, definition, and/or use of terms in the present disclosure shall prevail.

1. A simulation and optimization design method for an electric multiple unit (EMU) obstacle removal snowplow based on multi-physical field coupling, comprising:
S1: collecting a snow environmental parameter of a target line, wherein the snow environmental parameter includes at least snowfall data and snow accumulation data;
S2: establishing a soft sphere model of snow particles and determining a contact force between the snow particles using a Hertz-Mindlin with JKR cohesion contact model;
S3: performing snow accretion simulation based on a wall snow accretion criterion using a discrete phase model, and then verifying correctness of a snow removal resistance formula in the snow accretion simulation by comparing with preset snow removal experimental data;
S4: establishing an obstacle removal snowplow model using a parametric modeling approach, and introducing a shape parameter into the snow removal resistance formula based on a simulation result of the snow accretion simulation to simplify a running resistance coefficient, and then evaluating snow removal performance of the obstacle removal snowplow under a preset shape parameter combination to determine the snow removal resistance formula of the obstacle removal snowplow;
S5: adding a train nose to the obstacle removal snowplow model to form a whole vehicle model and performing simulation based on the whole vehicle model, and then correcting the snow removal resistance formula and generating an obstacle removal snowplow selection recommendation;
S6: performing simulation under a preset snow depth and running velocity to obtain train forces and snow removal paths under different snow depths and running velocities, and then generating a maximum velocity capable of satisfying an actual operation requirement under different snow depths based on a preset constraint condition; and
S7: outputting an optimal design parameter of the obstacle removal snowplow.

2. The simulation and optimization design method of claim 1, wherein in the operation S2, the establishing a soft sphere model of snow particles includes:
the soft sphere model of snow particles simplifying a contact process between particles into damped vibration of a spring oscillator, and an equation of motion of the damped vibration of the spring oscillator being expressed as:
m\ddot{x}+c\dot{x}+kx=0, wherein x is a displacement deviating from an equilibrium position, m is a mass of the oscillator, and c and k are a spring damping coefficient and an elastic coefficient, respectively;
a normal elastic coefficient kₙ is:
$${k}_{n} = \frac{4}{3} {( \frac{1 - {v}_{i}^{2}}{{E}_{i}} + \frac{1 + {v}_{j}^{2}}{{E}_{j}} )}^{- 1} {( \frac{{R}_{i} + {R}_{j}}{{R}_{ij}} )}^{- 1 / 2} ,$$
wherein E and v are an elastic modulus and a Poisson's ratio of a particle material, respectively, R is a particle radius, subscripts i and j represent a contacting particle i and a contacting particle j, respectively, and when the particle i and the particle j belong to a homogeneous material and have equal particle radii, kₙ is
$${k}_{n} = \frac{\sqrt{2 RE}}{3 ( 1 - {v}^{2} )} ;$$
a tangential elastic coefficient kₜ is:
$${k}_{t} = 8 {{α}^{- 1 / 2} ( \frac{1 - {v}_{i}^{2}}{{G}_{i}} + \frac{1 + {v}_{j}^{2}}{{G}_{j}} )}^{- 1} {( \frac{{R}_{i} + {R}_{j}}{{R}_{ij}} )}^{- 1 / 2} ,$$
wherein α is a normal overlap, Gᵢ and Gⱼ are a shear modulus of the particle i and a shear modulus of the particle j, respectively, and when the particle i and the particle j belong to a homogeneous material and have equal particle radii, kₜ is
$${k}_{t} = \frac{2 \sqrt{2 RG}}{3 ( 1 - {v}^{2} )} {α}^{- 1 / 2} .$$

3. The simulation and optimization design method of claim 2, wherein the determining the spring damping coefficient includes:
in response to determining that a spring oscillator with a mass m is in a critical damping state, mechanical energy decaying at a fastest velocity, in this case, a normal damping coefficient cₙ and a tangential damping coefficient cₜ being respectively expressed as:
$${c}_{n} = 2 \sqrt{m {k}_{n}}$$
$${c}_{t} = 2 \sqrt{m {k}_{t}}$$
or
coupling the normal damping coefficient with a restitution coefficient e:
$${c}_{n} = \frac{2 ln e}{\sqrt{{π}^{2} + ln e}} \sqrt{m {k}_{n}}$$
wherein e is determined by experiment.

4. The simulation and optimization design method of claim 1, wherein in the operation S2, the determining the Hertz-Mindlin with JKR cohesion contact model includes:
determining a normal force JKR based on an overlap δ, an interaction parameter, and a surface energy γ:
$${F}_{JKR} = - 4 \sqrt{π γ {E}^{*}} {a}^{\frac{3}{2}} + \frac{4 {E}^{*}}{3 {R}^{*}} {a}^{3} , δ = \frac{{a}^{2}}{R} * - \sqrt{\frac{4 π γ a}{{E}^{*}}} ,$$
wherein E* is an equivalent Young's modulus, and R* is an equivalent radius;
an expression of a damping force
$${F}_{n}^{d}$$
being expressed as:
$${F}_{n}^{d} = - 2 \sqrt{\frac{5}{6}} β \sqrt{{S}_{n} {m}^{*}} {v}_{n}^{\overline{rel}} , wherein {m}^{*} = {( \frac{1}{{m}_{1}} + \frac{1}{{m}_{i}} )}^{- 1}$$
is an equivalent mass
$${v}_{n}^{\overline{rel}}$$
is a normal component of a relative velocity, and expressions of β and Sₙ are:
$$β = \frac{ln e}{\sqrt{{π}^{2} + ln e}} , {S}_{n} = 2 {E}^{*} \sqrt{{R}^{*} {δ}_{n}} ;$$
an expression of a tangential force
$${F}_{t}^{d}$$
being expressed as:
$${F}_{t}^{d} = - 2 \sqrt{\frac{5}{6}} β \sqrt{{S}_{t} {m}^{*}} {v}_{t}^{\overline{rel}} ,$$
wherein Sₜ is a tangential overlap,
Sₜ=8G*\sqrt{R*δₙ}, G*is an equivalent shear modulus, and
$${v}_{t}^{\overline{rel}}$$
is a tangential component of the relative velocity; wherein the tangential force is limited by Coulomb friction μₛFₙ, μₛ is a static friction coefficient, and rolling friction applies a moment on a contact surface:
τᵢ=−μᵣ Fₙ Rᵢωᵢ, wherein μᵣ is a rolling friction coefficient, Rᵢ is a distance from a contact point to a center of mass, and ωᵢ is a unit angular velocity vector of an object at the contact point;
a maximum spacing with non-zero cohesion between particles being determined by:
$${δ}_{c} = \frac{{a}^{2}}{{R}^{*}} - \sqrt{\frac{4 π γ a}{{E}^{*}}} ,$$
$${a}_{c} = {[ \frac{9 π γ {R}^{* 2}}{2 {E}^{*}} ( \frac{3}{4} - \frac{1}{\sqrt{2}} ) ]}^{\frac{1}{3}} ,$$
wherein in response to determining that δ<δ_{c}, the model returns 0;
in response to determining that the particles are not in actual contact and a spacing is less than δ_{c}, the cohesion reaches a maximum value, and thus, a maximum cohesion is expressed as:
$${F}_{pullout} = - \frac{3}{2} π γ {R}^{*} ;$$
and
a force required to separate two particles depends on a liquid surface tension γₛ and a contact angle.

5. The simulation and optimization design method of claim 1, wherein in the operation S3, the discrete phase model includes:
a continuity equation and a momentum conservation equation of the discrete phase model being respectively expressed as:
$$\frac{\partial ( {α}_{f} {ρ}_{f} )}{\partial t} + ∇ \cdot ( {ρ}_{f} {α}_{f} u ) = 0 ,$$
$$\frac{\partial ( {α}_{f} {ρ}_{f} u )}{\partial t} + ∇ \cdot ( {ρ}_{f} {α}_{f} u u ) = - {α}_{f} ∇ P - {F}_{f - p} + {α}_{f} ∇ \cdot τ + {α}_{f} {ρ}_{f} g ,$$
wherein ρ_{f}, u, and P are a density, a velocity, and a pressure of a fluid, respectively, t is time, g is a gravitational acceleration, α_{f} is a fluid volume fraction, determined by
$${α}_{f} = 1 - {V}_{p} / {V}_{c} ,$$
wherein V_{c} and Vₚ are a total volume of a control volume unit and a particle volume, respectively; F_{f-p} is a force between an air phase and a snow phase, mainly a particle drag force F_{drag}; τ is a fluid viscous stress tensor, determined by
$$τ = - \frac{2}{3} ( {μ}_{f} ∇ \cdot u ) I + {μ}_{f} [ ( ∇ u ) + {( ∇ u )}^{- 1} ] ,$$
wherein I is a unit tensor, and μ_{f} is a fluid viscosity including a kinematic viscosity and a turbulent viscosity;
for the snow phase, the snow particles being regarded as spheres, and a force equilibrium equation of the snow particles being expressed as:
$${m}_{p} \frac{{du}_{p}}{dt} = {F}_{d r a g} + \frac{{m}_{p} ( {ρ}_{p} - {ρ}_{f} ) g}{{ρ}_{p}} + F ,$$
wherein mₚ, uₚ, and ρₚ are a mass, a velocity, and a density of the snow particles, respectively, and F is an additional external field; wherein,
$${F}_{d r a g} = \frac{18 {μ}_{f}}{{ρ}_{d} {d}_{p}^{2}} \frac{{C}_{D} {R}_{e , p}}{24} ( {u}_{f} - {u}_{p} ) ,$$
wherein dₚ is a snow particle diameter, C_{D} is a particle drag coefficient, which is determined based on a smooth sphere model by a set of empirical constants a₁, a₂ and a₃ determined by a range of a particle Reynolds number R_{e,p};
$${C}_{D} = {a}_{1} + \frac{{a}_{2}}{{R}_{e , p}} + \frac{{a}_{3}}{{R}_{e , p}^{2}} ;$$
determining a particle trajectory:
$$\frac{dx}{dt} = {u}_{p} ,$$
and solving the differential equation along each coordinate direction to obtain a trajectory of the discrete phase; and
solving a control equation of a fluid phase using a conventional SIMPLE approach, and then solving an equation of motion of the particles in a flow field based on an explicit time integration approach.

6. The simulation and optimization design method of claim 5, wherein in the operation S3, the wall snow accretion criterion includes:
in response to an incident angle α being less than a capture angle αₜ, the snow particles being captured by a wall surface;
in response to a local friction velocity being less than a preset threshold friction velocity, the snow particles being not carried away by wind, resulting in accumulation;
in response to a particle collision velocity uₚ being less than a critical capture velocity uₜᵣₐₚ, a viscous force of the wall surface on the snow particles being relatively large, and the snow particles being captured; and
in response to the snow particles satisfying the above three wall snow accretion criteria, the snow particles being captured by the wall surface and stably accumulated on the wall surface to achieve snow accretion on the wall surface.

7. The simulation and optimization design method of claim 6, further comprising:
determining the capture angle αₜ and the critical capture velocity uₜᵣₐₚ based on physical property data of the snow particles, wall property data of the wall surface, and a wall temperature.

8. The simulation and optimization design method of claim 7, wherein the determining the capture angle αₜ and the critical capture velocity uₜᵣₐₚ based on physical property data of the snow particles, wall property data of the wall surface, and a wall temperature includes:
determining the capture angle αₜ and the critical capture velocity trap based on the physical property data, the wall property data, the wall temperature, an environmental temperature, and an environmental wind velocity through a parameter determination model, the parameter determination model being a machine learning model.

9. The simulation and optimization design method of claim 1, wherein in the operation S4, the establishing an obstacle removal snowplow model using a parametric modeling approach includes:
S41: selecting a horizontal plane, and determining a specific position and a length of a line segment based on a snowplow opening angle and a train width;
S42: selecting a vertical symmetry plane of the snowplow, and determining a leading edge line segment of the snowplow and an angle of attack constraint line based on a total height of the snowplow and a lower half height of the snowplow;
S43: generating a lower half plane of the snowplow based on the determined line segment;
S44: determining a reference plane where a rear spline curve is located by projecting a bottom line of a lower half plane of the snowplow onto an upper edge plane of the snowplow by converting entity references;
S45: determining the rear spline curve based on a suppression angle and the train width, wherein boundary conditions include tangency to a plane determined by the angle of attack, a suppression angle constraint, and a suppression angle height constraint;
S46: determining a front spline curve, wherein boundary conditions include a foremost protrusion distance of the snowplow and tangency to the angle of attack plane and the line segment; and
S47: generating curved surfaces and planes to complete modeling of half of the snowplow, and then mirroring the entity to complete modeling of the snowplow.

10. The simulation and optimization design method of claim 9, wherein in the operation S4, the method further comprises:
a calculation expression of snow removal resistance: Fₚ=ChwρV², wherein h is a snow removal depth, w is a snow removal width, ρ is a snow density, V is a running velocity; C is a running resistance coefficient, C=C₀+C₁+C₂, wherein C₀ is determined based on linear interpolation by looking up a preset table, C₁=0.028 (δ+2γ)×10⁻⁴, δ is the suppression angle, γ is the angle of attack; in C₂: when θ<45°, C₂={5.64+0.008×(45−θ)}×10⁻⁴; when 45°≤θ≤90°,
C₂={5.64+0.0025× (θ−45)}×10⁻⁴, wherein θ is an inclination angle.

11. The simulation and optimization design method of claim 1, wherein in the operation S6, the method comprises:
performing simulation at the preset snow depth and running velocity with a constraint condition that a wheel load reduction rate does not exceed a preset value and a driver's field of view is clear, and generating the maximum velocity capable of satisfying the actual operation requirement under different snow depths.

12. The simulation and optimization design method of claim 11, wherein the constraint condition further includes:
a structural stress at a connection between the obstacle removal snowplow and the train nose satisfying a first preset condition, and a side cast angle of snow at an end of the obstacle removal snowplow satisfying a second preset condition.

13. The simulation and optimization design method of claim 1, wherein a plurality of preset shape parameter combinations are provided, and the operation S4 further includes:
determining a plurality of candidate shape parameter combinations based on an evaluation result of the snow removal performance of the obstacle removal snowplow under the plurality of preset shape parameter combinations;
determining a target shape parameter combination based on the plurality of candidate shape parameter combinations and physical verification results of snowplow wedges corresponding to the plurality of candidate shape parameter combinations; and
determining the snow removal resistance formula of the obstacle removal snowplow based on the snow removal performance of the obstacle removal snowplow under the target shape parameter combination.

14. The simulation and optimization design method of claim 13, wherein a plurality of preset shape parameter combinations are provided, and the operation S5 further includes:
adding the train nose to the obstacle removal snowplow model corresponding to the target shape parameter combination to form the whole vehicle model and performing simulation based on the whole vehicle model to correct the snow removal resistance formula and generate the obstacle removal snowplow selection recommendation.

15. The simulation and optimization design method of claim 1, wherein the preset shape parameter combination includes an opening angle, an inclination angle, an angle of attack, and a suppression angle, and the method further comprises:
determining a two-dimensional cutting path of a leading edge plate and a side plate of the obstacle removal snowplow based on the opening angle and the inclination angle;
controlling a cutting device to perform cutting operation based on the two-dimensional cutting path;
determining a bending line position and a bending angle of a guide inclined plate and a rear guide plate of the obstacle removal snowplow based on the angle of attack and the suppression angle;
controlling a bending device to perform bending operation based on the bending line position and the bending angle.

16. The simulation and optimization design method of claim 1, wherein the operation S2 further includes:
determining, at each preset duration, a snow particle pair and a snow particle-snowplow surface pair which are in contact;
generating a normal contact force, a tangential friction force, and a JKR cohesion of the snow particle pair and the snow particle-snowplow surface pair based on the contact model; and
updating positions and velocities of a plurality of snow particles based on the normal contact force, the tangential friction force, the JKR cohesion, and a preset rule.

17. The simulation and optimization design method of claim 1, wherein the operation S5 includes:
controlling, at each preset operation duration, a computational fluid dynamics solver and a discrete element manner solver to perform bidirectional coupling operation, wherein the bidirectional coupling operation includes:
the computational fluid dynamics solver generating and transmitting a force exerted by air on a plurality of snow particles to the discrete element method solver; and
the discrete element method solver generating and transmitting positions of the plurality of snow particles and a reaction force on the air to the computational fluid dynamics solver.

18. A simulation and optimization design method for an EMU obstacle removal snowplow based on multi-physical field coupling adopting the method of claim 1, comprising:
a data acquisition module configured to collect a snow environmental parameter of a target line, wherein the snow environmental parameter includes at least snowfall data and snow accumulation data;
a model processing module configured to establish a soft sphere model of snow particles and determine a contact force between the snow particles using a Hertz-Mindlin with JKR cohesion contact model;
a simulation module configured to perform snow accretion simulation based on a wall snow accretion criterion using a discrete phase model, and then verify correctness of a snow removal resistance formula in the snow accretion simulation by comparing with preset snow removal experimental data;
a resistance determination module configured to establish an obstacle removal snowplow model using a parametric modeling approach, and introduce a shape parameter into the snow removal resistance formula based on a simulation result of the snow accretion simulation to simplify a running resistance coefficient, and then evaluate snow removal performance of the obstacle removal snowplow under a preset shape parameter combination to determine the snow removal resistance formula of the obstacle removal snowplow;
an obstacle removal selection module configured to add a train nose to the obstacle removal snowplow model to form a whole vehicle model and performing simulation based on the whole vehicle model, and then correct the snow removal resistance formula and generate an obstacle removal snowplow selection recommendation;
a design optimization module configured to perform simulation under a preset snow depth and running velocity to obtain train forces and snow removal paths under different snow depths and running velocities, and then generate a maximum velocity capable of satisfying an actual operation requirement under different snow depths based on a preset constraint condition;
a design output module configured to output an optimal design parameter of the obstacle removal snowplow.
